(19) United States
(12) Patent Application Publication
(10) Pub. No.: US 2019/0006122 A1
(43) Pub. Date: Jan. 3, 2019

(54) ELECTROCHEMICAL ENERGY STORAGE DEVICES

(71) Applicant: RAMOT AT TEL-AVIV UNlVERSITY LTD., Tel Aviv (IL)

(72) Inventors: Emanuel PELED, Even Yehuda (IL); Meital GOOR DAR, Tel Aviv (IL); Tal CHEN, Kfar Saba (IL)

(21) Appl. No.: 15/741,371

(22) PCT Filed: Jun. 27, 2016
(86) PCT No.: PCT/IL2016/050684

§ 371 Date: Jan. 2, 2018

Related U.S. Application Data
(60) Provisional application No. 62/187,265, filed on Jul. 1, 2015.

(51) Int. Cl. H01G 11/04; H01G 11/62; H01M 10/36; H01M 4/58; H01G 11/86; H01G 11/46; H01G 11/26

(52) U.S. Cl. CPC H01G 11/04; H01G 11/62; H01M 10/36; H01G 11/26; H01G 11/86; H01G 11/46; H01M 4/5815

(57) ABSTRACT

The present invention provides electrochemical energy storage devices, comprising at least one electrochemical cell comprising a first porous electrode, a second porous electrode, an aqueous or non-aqueous electrolyte being in contact with said first porous and second porous electrodes and a porous separator separating the first porous electrode from the second porous electrode, wherein: (a) the electrolyte comprises a first dissolved salt comprising a trivalent post-transition metal cation; and/or (b) the first porous electrode, the second porous electrode or both electrodes comprise submicron particles of a precipitated salt comprising a cation selected from the group consisting of Pb²⁺, Sn²⁺, and Sb²⁺; and/or (c) the second porous electrode comprises pyrite (FeS₂) submicron particles. Further provided are methods of formation of the electrochemical energy storage devices.

### FIELD OF THE INVENTION

The present invention is directed to electrochemical energy storage devices, for use in small or large-scale energy storage applications.

### BACKGROUND OF THE INVENTION

Ongoing technological advances in such disparate areas as consumer electronics, transportation, and energy generation and distribution are often hindered by the capabilities of current energy storage/conversion systems, thereby driving the search for high-performance power sources that are also economically viable, safe to operate, and have limited environmental impact. Electrochemical capacitors (ECs), also termed supercapacitors or ultracapacitors, are one class of energy-storage devices that fill the gap between the high specific energy of batteries and the high specific power of conventional electrostatic capacitors.

The stationary energy storage market needs ECs for short to medium duration applications of energy storage, which are characterized by the need for high power for relatively short periods of time. These include power quality ride-through applications, power stabilization, adjustable speed drive support, temporary support of distributed resources during load steps, voltage flicker mitigation and many other applications. Most of said applications involve from only a few seconds up to about 20 minutes of energy storage. Other applications include backup power (uninterruptible power supply) and power management systems used in distributed generation and wind and solar energy generating stations. Such stationary energy storage devices should be able to run for minutes up to tens of hours.

The consumer electronics and computer market needs small high-frequency devices in order to reduce battery size. ECs are thus ideal candidates for use in microelectronics.

ECs can be further used in the transport energy storage market as load-leveling devices in combination with batteries in electric and hybrid vehicles. Transportation applications include braking energy recuperation and torque augmentation systems for hybrid-electric buses, trucks and autos and electric rail vehicles, vehicle power network smoothing and stabilization, engine starting systems for internal combustion vehicles, and burst power for idle stop-start systems.

The most widely available commercial EC is an electric double-layer capacitor (EDLC) based on a symmetric configuration of two high-surface-area carbon electrodes separated by an electrolyte. Charge is stored in the electric double-layer that arises at all electrode/electrolyte interfaces, resulting in effective capacitances of 10-40 μFcm⁻² (for flat plates). On charge the anions are adsorbed on one electrode and the cations on the other one. Aqueous-based activated carbon (AC) supercapacitors are promising low cost devices for providing high power densities, since water is a low-cost and non-toxic material, aqueous electrolytes do not require specific manufacturing conditions, and possess relatively high conductivity. However, energy density of aqueous electrolyte supercapacitors is relatively low due to the limited cell voltage. An efficient way to improve the cell voltage in terms of the energy density is to use organic electrolytes with a wider electrochemical stability window than water. Organic electrolytes including the combination of a solvent with different salts could enable the maximum cell voltage to reach more than 3V, a value three times higher than the maximum cell voltage of aqueous-based supercapacitors. However, such improvements inevitably sacrifice the capacitance and equivalent series resistance, which precludes it from easily reaching-high power density. The organic electrolytes also suffer from toxicity, flammability and safety hazards and from high manufacturing costs.

Another approach to increasing the energy density of double layer capacitors includes addition of electroactive species to the electrolyte. International patent application No. 2014/060886 to some of the inventors of the present invention pertains to a double-layer capacitor (DLC) including an electrolyte having an electrochemically active species dissolved therein. The electrochemically active species consists of a material that undergoes oxidation at one electrode and undergoes reduction at another electrode during charge and discharge processes of the DLC.

Specific energy can be further enhanced by moving to asymmetric configurations and selecting electrode materials that store charge via rapid and reversible pseudo electron-exchange reactions on or near the electrode surface in addition to the electrical double-layer capacitance. The exact mechanism of charge storage is not well known. Such materials often express broad and symmetric charge-discharge profiles that are reminiscent of those generated by double-layer capacitance, thus the term “pseudocapacitance” is used to describe their charge-storage mechanism. Many transition metal oxides, metal nitrides, and conducting polymers exhibit pseudocapacitance. Pseudocapacitance-based charge storage is most effective in aqueous electrolytes, and the corresponding enhancements in charge-storage capacity can compensate for the restricted voltage window of water, resulting in energy densities for aqueous asymmetric (also termed hybrid) ECs that are competitive with non-aqueous conventional EDLCs. By using other electrode materials in addition to carbons, asymmetric EC designs also circumvent the main limitation of aqueous electrolytes by extending their operating voltage window beyond the thermodynamic 1.2 V limit to operating voltages approaching 2 V.

In the asymmetric AC/metal oxide electrochemical capacitors, one electrode stores charge through a reversible, nonfaradaic reaction of ion adsorption/desorption on the surface of an active carbon, and the other electrode utilizes a reversible pseudo-redox reaction in a transition metal oxide electrode.

Transition metal oxide exhibiting the highest pseudocapacitance is RuO₂. However, since ruthenium is a noble metal, ruthenium oxides cannot be used in electrochemical capacitor applications on a large scale. An alternative metal oxide exhibiting capacitance-like behavior is manganese oxide, which is currently extensively used in the supercapacitor technology. In terms of specific capacitance, MnOx-based materials demonstrate a clear advantage compared to carbon-based materials that rely solely on double-layer capacitance.

The aqueous electrolyte of AC/manganese dioxide supercapacitors is typically mildly alkaline and contains Li⁺, Na⁺, or K⁺ ions. In the case it is used as the negative electrode on charge, the charge storage mechanism of manganese dioxides is based on the double injection and ejection of cations and electrons, in which the electrolyte cations intercalate into MnO₂ lattice and correspondingly Mn(IV) becomes Mn(III) to balance the charge. One univalent alkaline cation inserted into MnO₂ and one electron are stored.

One of the possible ways to increase energy density of aqueous-based asymmetric supercapacitors is the addition of divalent alkaline-earth cations. The effect of addition of Ca²⁺, Mg²⁺ and Ba²⁺ to aqueous electrolyte has been evaluated in asymmetric supercapacitors containing AC/MnO₂ electrodes [Xu et al., J. Electrochem. Soc. 2009, 156, 6, A435-A441]. Ca²⁺ was found to be the most suitable divalent ion for the asymmetric AC/MnO₂ supercapacitor electrolyte, due to the appropriate bare ion size and the smallest size of the hydrated ion, providing the energy density of 21 Wh/kg (of active mass) at a current density of 0.3 A/g.

U.S. Pat. No. 8,137,830, directed to an electrochemical storage device including a plurality of electrochemical cells connected electrically in series, wherein each cell includes an anode electrode, a cathode electrode and an aqueous electrolyte and the charge storage capacity of the anode electrode is less than the charge storage capacity of the cathode, also discloses electrolytes, which may include, inter alia, salts of alkaline earth metals (such as Ca or Mg).

Despite their attractive features, such as high pseudocapacitance and low cost, manganese oxide electrodes have several disadvantages. The capacitance of thick MnO₂ electrodes is ultimately limited by the poor electrical conductivity of MnO₂, while performance of a supercapacitor using a planar electrode ultrathin configuration is restricted because of low mass loading. The enhancement of electrical conductivity and charge-storage capability of manganese oxide can be achieved by incorporation of additional metal elements into the MnO₂ electrodes. The chemical modification of MnO₂ electrodes can be generally divided into two categories: one is mixed oxide electrodes containing other transition metal elements, such as Ni, Cu, Fe, V, Co, Mo and Ru. The other type is a modified MnO₂ electrode, which is realized through doping with small amounts of other metallic elements such as Al, Sn and Pb. The corresponding electrochemical properties indicate that the manipulation of defect chemistry by chemical modification has significant influence on the electronic conductivity and, in turn, on the specific capacitance and rate capacity [Weifeng Wei, et al., Chem. Soc. Rev., 2011, 40, 1697-1721].

The growing interest in MnOx-based ECs, and the drawbacks of MnOx electrode material, has also spurred interest in alternative negative electrode materials that exhibit pseudocapacitance in a complementary potential window to that for MnOx. Iron oxides were among the first such materials investigated, while other metal oxides such as SnO₂ and TiO₂, metal phosphates (Li(Ti₂(PO₄)₃), and conducting polymers (e.g., polyaniline, polypyrrole) are also potential contenders as negative electrodes for MnOx-based ECs.

Metal sulfides, such as, for example, molybdenum disulfide, have also been evaluated in the supercapacitor electrodes. MoS₂ has a higher intrinsic ionic conductivity, as compared to metal oxides and higher theoretical capacity, as compared to graphite. It has been shown that the supercapacitor performance of MoS₂ was comparable to carbon nanotubes (CNT) array electrodes [Soon J M, Loh K P, Electrochem Solid State Lett 2007, 10, A250-A254]. However, the electronic conductivity of MoS₂ is lower compared to graphite/CNTs, and the specific capacitance of MoS₂ is very limited. The combination of MoS₂ and other conducting materials may overcome these deficiencies, such as, for example, a 2-dimensional graphene analog MoS₂/MWCNT (molybdenum disulfide/multi-walled carbon nanotube) composite, which was reported to be a suitable electrode material for supercapacitors [K.-J. Huang et al., Energy 67, 2014, 234-240]. The MoS₂/MWCNT composites exhibited superior electrochemical performance to pure MWCNT and MoS₂.

Despite all the recent advances in the EC technology, in order for the supercapacitors to be commercially viable in either small or large-scale energy storage applications, energy density and capacity of the presently available supercapacitors should be increased, without compromising their cost and cycle life. There remains, therefore, an unmet need for high power devices and high energy density systems based on supercapacitors, employing novel types of electrodes and/or electrolytes, to be incorporated in various mobile and stationary applications.

### SUMMARY OF THE INVENTION

The present invention provides a low-cost electrochemical energy storage device, which can be used for short-term, as well, as long-term energy storage applications. The energy storage device according to the principles of the present invention can be configured to provide high power density (such as, for example, in the kW/kg range) and run for up to about 100 sec. Alternatively, the energy storage devices can be used for stationary applications, providing up to tens of hours of energy storage. The energy storage devices of the present invention are based on electrochemical cells, including symmetric or asymmetric electrochemical capacitors. Said energy storage devices provide higher energy density and/or higher specific capacity than the presently-known EC-based energy storage systems. The energy storage devices according to the principles of the present invention incorporate materials, which, according to the inventors' best knowledge, have not previously been used in the EC technology.

The present invention is based in part on an unexpected finding that introduction of such novel materials to the electrolyte and/or electrodes of symmetric or asymmetric ECs afforded for the increase in the specific capacity and/or energy density thereof, without compromising their cost and cycle life. For example, an EC having an electrolyte, which contained trivalent ions, such as, for example, Al³⁺, had higher energy density and specific capacity than a similar EC including a conventional monovalent ion (Na⁺) based electrolyte. To the inventors' best knowledge, aluminum has not previously been used in ECs due to its lower solution conductivity and lower solubility of its salts. It was, however, surprisingly found by the inventors of the present invention that aluminum cations provide higher capacitance than monovalent ions, which compensates for the lower conductivity of solutions containing aluminum cations.

Additional approach to increasing specific capacitance of the electrodes included incorporation of precipitated salts of some post-transition metals or metalloids, such as, but not limited to, lead or tin in pores of porous electrodes of an EC. It has been surprisingly found that the addition of said precipitated salts significantly increased the specific capacitance of the electrodes and energy density of the cells. It has been further unexpectedly found that pyrite (FeS₂) can be advantageously used as an electrode material in asymmetric electrochemical capacitors.

Thus, according to a first aspect, the present invention provides an electrochemical energy storage device, comprising at least one electrochemical cell comprising a first porous electrode, a second porous electrode, an electrolyte being in contact with said first porous and second porous electrodes, and a porous separator separating the first porous electrode from the second porous electrode, wherein: (a) the electrolyte comprises a first dissolved salt comprising a trivalent post-transition metal cation; and/or (b) the first porous electrode, the second porous electrode or both electrodes comprise submicron particles of a precipitated salt comprising a cation selected from the group consisting of Pb²⁺, Sn²⁺, and Sb²⁺; and/or (c) the second porous electrode comprises pyrite (FeS₂) submicron particles. The electrochemical storage device can be used for short term and for long term energy storage. The electrochemical cell can be selected from an electrochemical capacitor (EC) or a battery. Each possibility represents a separate embodiment of the invention. In some exemplary embodiments the electrochemical cell is an electrochemical capacitor. The electrochemical storage device can further comprise at least one battery.

According to some embodiments, the electrolyte comprises the first dissolved salt comprising a trivalent post-transition metal cation. The trivalent post-transition metal cation can be selected from the group consisting of Al³⁺, Ga³⁺ and combinations thereof. Each possibility represents a separate embodiment of the invention.

According to some embodiments, the electrolyte comprises a second dissolved salt selected from the group consisting of an alkali metal salt, an alkali earth metal salt and combinations thereof. Each possibility represents a separate embodiment of the invention.

The alkali metal salt can comprise a cation selected from the group consisting of Na⁺, K⁺, and Li⁺. The alkali earth metal salt can comprise a cation selected from the group consisting of Ca²⁺, Mg²⁺, and Ba²⁺. Each possibility represents a separate embodiment of the invention.

According to some embodiments, the electrolyte comprises a third dissolved salt comprising a tetravalent post-transition metal salt. The salt of the post-transition metal can comprise a cation selected from Pb²⁺ or Sn². Each possibility represents a separate embodiment of the invention.

According to some embodiments, the first salt, the second salt, and/or the third salt comprises an anion selected from the group consisting of a sulfate, perchlorate, nitrate, methanesulfonate, trifluoromethanesulfonate, chloride, bromide, hydroxyl, bis(perfluoroethylsulfonyl)imide, carboxylate, acetate, formate and combinations thereof. Each possibility represents a separate embodiment of the invention.

According to some embodiments, the concentration of the first dissolved salt is in the range of from about 0.1M to about 10M. According to some embodiments, the concentration of the second dissolved salt is in the range of from about 0.1M to about 10M. According to some embodiments, the concentration of the third dissolved salt is in the range of from about 0.0001M to about 1M.

In some embodiments, the electrolyte is an aqueous-based electrolyte.

In other embodiments, the electrolyte is an organic solvent-based electrolyte. The organic solvent can be selected from the group consisting of a cyclic carbonate, a linear carbonate, a linear formate, an ether-based organic solvent, an ionic liquid, and combinations thereof. Each possibility represents a separate embodiment of the invention. In further embodiments, the organic solvent is selected from the group consisting of ethylene carbonate, propylene carbonate (PC), diethyl carbonate (DEC), dimethyl carbonate (DMC), ethyl formate (EF), methyl formate (MF), 1-ethyl-3-methylimidazolium bis (trifluoromethylsulfonyl)imide, 1-ethyl-3-methylimidazolium trifluoromethanesulfonate, 1-hexyl-3-methylimidazolium hexafluorophosphate, 1-ethyl-3-methylimidazolium dicyanamide, 11-methyl-3-octylimidazolium tetrafluoroborate and combinations thereof. Each possibility represents a separate embodiment of the invention.

The first porous electrode can be a negative electrode or a positive electrode. The second porous electrode can be a negative electrode or a positive electrode. According to some currently preferred embodiments, the first porous electrode is a negative electrode and the second porous electrode is a positive electrode. According to further embodiments, the first porous electrode is configured to adsorb cations during charge of the electrochemical cell and the second porous electrode is configured to adsorb anions during charge.

According to some embodiments, the first porous electrode, the second porous electrode or both electrodes comprise a high surface area carbon material. The carbon material can be selected from the group consisting of carbon, graphite, carbon nanotubes, graphene, and combinations thereof. Each possibility represents a separate embodiment of the invention.

According to some embodiments, the first porous electrode, the second porous electrode or both electrodes comprise a transition metal oxide or sulfide. The transition metal oxide or sulfide can be selected from the group consisting of MnₙOₓ, TiOₓ, NiOₓ CoOₓ, SnOₓ, FeS_{y}, MoS_{y}, NiS_{y}, CoS_{y}, MnS_{y}, TiS_{y}, SnS_{y} and combinations thereof, wherein x ranges from 1.5 to 3, y ranges from 1.8 to 2.2 and n ranges from 1 to 2. Each possibility represents a separate embodiment of the invention.

In some embodiments, the second porous electrode comprises a transition metal oxide or sulfide. In further embodiments, the second electrode is a positive electrode. In some exemplary embodiments, the second porous electrode comprises MnₙOₓ. MnₙOₓ can include, inter alia, MnO₂ and Mn₂O₃. In other embodiments, the second porous electrode comprises MoS_{y}. The non-limiting example of MoS_{y} is MoS₂. In further exemplary embodiments, the second porous electrode comprises FeS₂.

In some embodiments, the first porous electrode comprises a combination of high surface area carbon material and a transition metal oxide or sulfide. In some embodiments, the second porous electrode comprises a combination of high surface area carbon material and a transition metal oxide or sulfide.

According to some embodiments, the electrochemical cell is a symmetric electrochemical capacitor. In certain such embodiments, the first porous electrode and the second porous electrode comprise high surface area carbon material. In certain embodiments, the first porous electrode and the second porous electrode comprise from about 5% to about 100% w/w high surface area carbon material. In further embodiments, the first porous electrode and the second porous electrode consist essentially of the high surface area carbon material.

According to some embodiments, the electrochemical cell is a symmetric electrochemical capacitor. In certain such embodiments, the first porous electrode and the second porous electrode comprise high surface area carbon material. In some embodiments, the second porous electrode comprises from about 0.001% w/w to about 10% w/w transition metal oxide or sulfide. In certain embodiments, the transition metal oxide is MnₙOₓ.

According to some embodiments, the electrochemical cell is a symmetric electrochemical capacitor. In certain such embodiments, the first porous electrode and the second porous electrode comprise transition metal oxide or sulfide. In certain such embodiments, the first porous electrode and the second porous electrode comprise the same transition metal oxide or sulfide. According to some embodiments, the first porous electrode and the second porous electrode comprise from about 50% w/w to about 99% w/w transition metal oxide or sulfide. In further embodiments, the first porous electrode and the second porous electrode consist essentially of the transition metal oxide or sulfide. In particular embodiments, the first porous electrode and the second porous electrode comprise a combination of the high surface area carbon material and the transition metal oxide or sulfide. According to some embodiments, the second porous electrode comprises from about 1% w/w to about 50% w/w high surface area carbon material. In certain embodiments, the transition metal oxide is MnₙOₓ. The transition metal sulfide can be selected from MoS_{y} and FeS₂. Each possibility represents a separate embodiment of the invention.

According to some embodiments, the electrochemical cell is an asymmetric electrochemical capacitor. In certain such embodiments, the first porous electrode comprises the high surface area carbon material and the second porous electrode comprises the transition metal oxide or sulfide. According to some embodiments, the second porous electrode comprises from about 50% w/w to about 99% w/w transition metal oxide or sulfide. In further embodiments, the second porous electrode consists essentially of the transition metal oxide or sulfide. In particular embodiments, the second electrode comprises a combination of the high surface area carbon material and the transition metal oxide or sulfide. According to further embodiments, the second porous electrode comprises from about 1% w/w to about 50% w/w high surface area carbon material. In certain embodiments, the transition metal oxide is MnₙOx. The transition metal sulfide can be selected from MoS_{y} and FeS₂. Each possibility represents a separate embodiment of the invention.

According to some embodiments, the electrochemical cell is an asymmetric electrochemical capacitor. In certain such embodiments, the first porous electrode comprises a first transition metal oxide or sulfide and the second porous electrode comprises a second transition metal oxide or sulfide, wherein the first transition metal oxide or sulfide and the second transition metal oxide or sulfide are different. According to some embodiments, the first porous electrode and the second porous electrode comprise from about 50% w/w to about 99% w/w transition metal oxide or sulfide. In further embodiments, the first porous electrode and the second porous electrode consist essentially of the transition metal oxide or sulfide. In particular embodiments, the first porous electrode and the second electrode comprise a combination of the high surface area carbon material and the transition metal oxide or sulfide. According to further embodiments, the first porous electrode and the second porous electrode comprise from about 1% w/w to about 50% w/w high surface area carbon material. In some embodiments, the first porous electrode comprises a transition metal oxide and the second porous electrode comprises a transition metal sulfide. The metal atoms of the transition metal sulfide and the transition metal may be same or different. Each possibility represents a separate embodiment of the invention. In particular embodiments, the first porous electrode comprises MoS_{y} and the second porous electrode comprises MnₙOₓ. In certain such embodiments, the first porous electrode is a negative electrode and the second porous electrode is a positive electrode.

According to some embodiments, the first porous electrode, the second porous electrode or both electrodes comprise the submicron particles of the precipitated salt comprising a cation selected from the group consisting of Pb²⁺, Sn²⁺, and Sb²⁺. The submicron particles may include nanoparticles. According to some embodiments, the submicron particles of the precipitated salt are deposited in the pores of the first porous electrode and/or of the second porous electrode. Each possibility represents a separate embodiment of the invention. The precipitated salt can comprise an anion selected from sulfate, carbonate and chloride. Each possibility represents a separate embodiment of the invention.

According to some embodiments, the weight of the submicron particles of the precipitated salt is from about 0.001% to about 70% of the total weight of the electrode. In some experimental embodiments, the weight of the submicron particles of the precipitated salt is from about 15% to about 30% of the total weight of the electrode.

According to some embodiments, the cation of the precipitated salt is reduced to metallic state on the first porous electrode and/or is oxidized to a metal oxide on the second porous electrode during potential cycling of the device. Each possibility represents a separate embodiment of the invention. In certain such embodiments, the first porous electrode can comprise submicron particles of a metal selected from the group consisting of Pb, Sn, and Sb. In further embodiments, the second porous electrode comprises submicron particles of a metal oxide selected from the group consisting of PbO₂, SnO₂, and SbO₂. In yet further embodiments, the submicron particles of the metal and/or of the metal oxide are deposited in the pores of the first porous electrode and/or of the second porous electrode.

According to some embodiments, the electrochemical cell is a symmetric electrochemical capacitor. In some embodiments, the first porous electrode and the second porous electrode comprise the high surface area carbon material and further comprise the precipitated salt. In other embodiments, the first porous electrode and the second porous electrode comprise the high surface area carbon material and the second porous electrode further comprises the precipitated salt.

According to some embodiments, the electrochemical cell is a symmetric electrochemical capacitor. In some embodiments, the first porous electrode and the second porous electrode comprise the same transition metal oxide or sulfide and further comprise the precipitated salt. In additional embodiments, the first porous electrode and the second porous electrode comprise the same transition metal oxide or sulfide and the second electrode further comprises the precipitated salt.

According to some embodiments, the electrochemical cell is an asymmetric electrochemical capacitor. In some embodiments, the first porous electrode comprises the high surface area carbon material and the precipitated salt and the second porous electrode comprises the transition metal oxide or sulfide and the precipitated salt. In other embodiments, the first porous electrode comprises the high surface area carbon material and the second porous electrode comprises the transition metal oxide or sulfide and the precipitated salt.

According to some embodiments, the electrochemical cell is an asymmetric electrochemical capacitor. In some embodiments, the first porous electrode comprises the first transition metal oxide or sulfide and the precipitated salt and the second porous electrode comprises the second transition metal oxide or sulfide and the precipitated salt. In additional embodiments, the first porous electrode comprises the first transition metal oxide or sulfide and the second porous electrode comprises the second transition metal oxide or sulfide and the precipitated salt. In certain such embodiments, said first metal oxide sulfide and the second transition metal oxide or sulfide are different

In certain embodiments the present invention provides a device comprising at least one electrochemical cell, wherein the first porous electrode comprises the high surface area carbon material, the second porous electrode comprises the high surface area carbon material and the electrolyte is an aqueous-based electrolyte comprising dissolved Al³⁺ salt. According to some embodiments, the first porous electrode and/or the second porous electrode further comprise the precipitated Pb²⁺ salt, which is deposited in the pores of said electrodes. In particular embodiments, said electrochemical cell is an electrochemical capacitor.

In certain embodiments the present invention provides a device comprising at least one electrochemical cell, wherein the first porous electrode comprises the high surface area carbon material, the second porous electrode comprises the transition metal oxide and the electrolyte is an aqueous-based electrolyte comprising dissolved Al³⁺ salt. The transition metal oxide can be selected from the group consisting of MnOₓ MoS_{y} and FeS₂, wherein x ranges from 1.5 to 3 and y ranges from 1.8 to 2.2. According to particular embodiments, the transition metal sulfide comprises FeS₂. According to some embodiments, the first porous electrode and/or the second porous electrode further comprise the precipitated Pb²⁺ salt, which is deposited in the pores of said electrodes. In particular embodiments, said electrochemical cell is an electrochemical capacitor.

In certain embodiments the present invention provides a device comprising at least one electrochemical cell, wherein the first porous electrode and the second porous electrode comprise the high surface area carbon material and the submicron particles of the precipitated salt comprising a cation selected from the group consisting of Pb²⁺, Sn²⁺, and Sb²⁺, wherein the submicron particles are deposited in the pores of said electrodes. According to particular embodiments, the precipitated salt comprises a PbSO₄ salt. In particular embodiments, said electrochemical cell is an electrochemical capacitor.

In certain embodiments the present invention provides a device comprising at least one electrochemical cell, wherein the first porous electrode comprises the high surface area carbon material and the second porous electrode comprises the metal oxide or sulfide and wherein the first electrode and the second electrode further comprise the submicron particles of the precipitated salt comprising a cation selected from the group consisting of Pb²⁺, Sn²⁺, and Sb²⁺, wherein the submicron particles are deposited in the pores of said electrodes. The transition metal oxide can be selected from the group consisting of MnOₓ MoS_{y} and FeS₂, wherein x ranges from 1.5 to 3 and y ranges from 1.8 to 2.2. According to particular embodiments, the transition metal sulfide comprises FeS₂. According to particular embodiments, the precipitated salt comprises a PbSO₄ salt. In particular embodiments, said electrochemical cell is an electrochemical capacitor.

In certain embodiments the present invention provides a device comprising at least one electrochemical cell, wherein the first porous electrode comprises the high surface area carbon material and the second porous electrode comprises FeS₂ submicron particles. The submicron particles may include nanoparticles. In particular embodiments, said electrochemical cell is an electrochemical capacitor.

According to some embodiments, the electrochemical cell further comprises a first current collector and a second current collector.

According to some embodiments, the device according to the principles of the present invention comprises from about 2 to about 10000 electrochemical cells connected in series and/or in parallel. In certain embodiments, the device comprises from about 10 to about 1000 electrochemical cells. In other embodiments, the device comprises from about 100 to about 300 electrochemical cells.

According to various embodiments, the device according to the principles of the present invention is configured to provide capacity for operation for up to about 100 sec. According to various embodiments, the device according to the principles of the present invention is configured to provide capacity for operation for from about 100 sec to about 200 h

In another aspect, the present invention provides a method for forming an electrochemical energy storage device comprising at least one electrochemical cell, the method comprising: (a) forming a first porous electrode and a second porous electrode; (b) separating the first porous electrode from the second porous electrode by a porous separator; (c) forming an electrolyte, comprising dissolving a first salt comprising a trivalent post-transition metal cation in water or in an organic solvent; and (d) filling the separator with the electrolyte, wherein the electrolyte is in contact with the first porous electrode and with the second porous electrode. The electrochemical cell can be selected from an electrochemical capacitor or a battery. Each possibility represents a separate embodiment of the invention.

According to some embodiments, the trivalent post-transition metal cation is selected from the group consisting of Al³⁺, Ga³⁺ and combinations thereof.

According to some embodiments, the method comprises dissolving a second salt selected from the group consisting of an alkali metal salt, an alkali earth metal salt and combinations thereof. The salt of the alkali metal can comprise a cation selected from the group consisting of Na⁺, K⁺, and Li⁺. The salt of the alkali earth metal can comprise a cation selected from the group consisting of Ca²⁺, Mg²⁺ and Ba²⁺.

According to further embodiments, the method comprises dissolving a third salt comprising a tetravalent post-transition metal salt. The salt of the post-transition metal can comprise a cation selected from Pb²⁺ or Sn²⁺.

In some embodiments, the first salt, the second salt, and/or the third salt comprises at least one anion selected from the group consisting of a sulfate, perchlorate, nitrate, methanesulfonate, trifluoromethanesulfonate, chloride, bromide, hydroxyl, bis(perfluoroethylsulfonyl)imide, carboxylate, acetate and formate.

According to some embodiments, the first porous electrode, the second porous electrode or both electrodes comprise a high surface area carbon material, selected from the group consisting of carbon, graphite, carbon nanotubes, graphene, and combinations thereof. Each possibility represents a separate embodiment of the invention.

According to some embodiments, the second porous electrode comprises a transition metal oxide or sulfide, selected from the group consisting of MnₙOₓ TiOₓ, NiOₓ CoOₓ, SnOₓ, FeS_{y}, MoS_{y}, NiS_{y}, CoS_{y}, MnS_{y}, TiS_{y}, SnS_{y} and combinations thereof, wherein x ranges from 1.5 to 3, y ranges from 1.8 to 2.2 and n ranges from 1 to 2. In some embodiments, the second porous electrode comprises a combination of the high surface area carbon and the transition metal oxide or sulfide.

In another aspect, the present invention provides a method for forming an electrochemical energy storage device comprising at least one electrochemical cell, the method comprising: (a) forming a first porous electrode and a second porous electrode; (b) filling the first porous electrode, the second porous electrode or both electrodes with an aqueous-based or an organic solvent-based solution comprising a dissolved salt comprising a cation selected from the group consisting of Pb²⁺, Sn²⁺, and Sb²⁺; (c) drying the first porous electrode, the second porous electrode or both electrodes; (d) separating the first porous electrode from the second porous electrode by a porous separator; (e) filling the separator with an electrolyte comprising an anion, which forms a precipitated salt with said cation, wherein the electrolyte is in contact with the first porous electrode and with the second porous electrode. The electrochemical cell can be selected from an electrochemical capacitor or a battery. Each possibility represents a separate embodiment of the invention.

According to some embodiments, said anion is selected from the group consisting of sulfate, carbonate and chloride.

According to some embodiments, the method further comprises applying potential to the device to reduce the cation of the precipitated salt to a metallic state on the first porous electrode and to oxidize the cation of the precipitated salt to a metal oxide on the second porous electrode.

According to some embodiments, the electrolyte comprises at least one cation selected from the group consisting of H⁺, Na⁺, K⁺, Li⁺, Ca²⁺, Mg²⁺, Ba²⁺, Al³⁺, and Ga³⁺. According to further embodiments, the electrolyte further comprises at least one anion selected from the group consisting of a perchlorate, nitrate, methanesulfonate, trifluoromethanesulfonate, chloride, bromide, hydroxyl, bis(perfluoroethylsulfonyl)imide, carboxylate, acetate and formate.

According to some embodiments, the first porous electrode and/or the second porous electrode comprises a high surface area carbon material, selected from the group consisting of carbon, graphite, carbon nanotubes, graphene, and combinations thereof, wherein the high surface area carbon material is configured to incorporate the precipitated salt within the pores thereof. Each possibility represents a separate embodiment of the invention.

According to some embodiments, the second porous electrode comprises a transition metal oxide or sulfide, selected from the group consisting of MnₙOₓ TiOₓ, NiOₓ CoOₓ, SnOₓ, FeS_{y}, MoS_{y}, NiS_{y}, CoS_{y}, MnS_{y}, TiS_{y}, SnS_{y} and combinations thereof, wherein x ranges from 1.5 to 2, y ranges from 1.8 to 2.2 and n ranges from 1 to 2, wherein the transition metal oxide or sulfide is configured to incorporate the precipitated salt within the pores thereof. In some embodiments, the second porous electrode comprises a combination of the high surface area carbon and the transition metal oxide or sulfide.

In another aspect, the present invention provides a method for forming an electrochemical energy storage device comprising at least one electrochemical cell, the method comprising: (a) forming a first porous electrode and a second porous electrode, wherein the second porous electrode comprises pyrite (FeS₂) submicron particles; (b) separating the first porous electrode from the second porous electrode by a porous separator; and (c) filling the separator with an aqueous-based or an organic solvent-based electrolyte, wherein the electrolyte in in contact with the first porous electrode and with the second porous electrode. The electrochemical cell can be selected from an electrochemical capacitor or a battery. Each possibility represents a separate embodiment of the invention.

According to some embodiments, the first porous electrode comprises a high surface area carbon material, selected from the group consisting of carbon, graphite, carbon nanotubes, graphene, and combinations thereof. Each possibility represents a separate embodiment of the invention.

According to some embodiments, the second porous electrode further comprises a high surface area carbon material, selected from the group consisting of carbon, graphite, carbon nanotubes, graphene, and combinations thereof. Each possibility represents a separate embodiment of the invention.

According to some embodiments, the electrolyte comprises at least one cation selected from the group consisting of H⁺, Na⁺, K⁺, Li⁺, Ca²⁺, Mg²⁺, Ba²⁺, Pb²⁺, Sn²⁺, Sb²⁺, Pb²⁺, Sn²⁺, Sb²⁺, Al³⁺, and Ga³⁺. According to further embodiments, the electrolyte comprises at least one anion selected from the group consisting of a sulfate, hydrogen sulfate, perchlorate, nitrate, methanesulfonate, trifluoromethanesulfonate, chloride, bromide, hydroxyl, bis(perfluoroethylsulfonyl)imide, carboxylate, acetate and formate.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1: Schematic representation of an electrochemical capacitor configured in a stainless steel coin cell. The electrochemical capacitor cell includes a first electrode (anode), a second electrode (cathode), a glass separator, two spacers, a spring and a sealing ring, which are sandwiched between a top cover and a base cover of the coin cell.

FIG. 2A: Voltage profile and FIG. 2B: Cell life of symmetric cell AlSulC1b, containing an aluminum salt-based electrolyte. The cell was operated under constant current at 10 mA in the potential window of 0.1-1.6V.

FIG. 2C: Voltage profile and FIG. 2D: Cell life of symmetric cells AlSu 5b (comprising aluminum salt-based electrolyte, pH=3) and NaSu_1c (comprising sodium salt-based electrolyte, pH=3). The cells were operated under constant current at 1 mA in the potential window of 0.1-1.8V.

FIG. 3A: Voltage profile and FIG. 3B: Cell life of symmetric cell Pb7b, containing electrodes comprising precipitated lead salt. The cell was operated under constant current at 10 mA in the potential window of 0.1-1.8V.

FIG. 3C: Energy efficiency and coulombic efficiency of symmetric cell Pb11a, containing electrodes comprising precipitated lead salt. The cell was operated under constant current at 10 mA in the potential window of 0.1-2V.

FIG. 4A: Voltage profile and FIG. 4B: Cell life of asymmetric cell AlSO4_MnO2_1b, containing MnO₂-based second electrode and aluminum salt-based electrolyte. The cell was operated under constant current at 1 mA in the potential window of 0.1-1.5V.

FIG. 4C: Voltage profile and FIG. 4D: Cell life of asymmetric cells AlSO4_MnO2_2a (comprising aluminum salt-based electrolyte, pH=3) and NaSO4_MnO2_2b (comprising sodium salt-based electrolyte, pH=3), the cells containing MnO₂-based second electrode. The cells were operated under constant current at 1 mA in the potential window of 0.1-1.6V.

FIG. 4E: Voltage profile and FIG. 4F: Cell life of asymmetric cell AlSO4_Mn2O3_7d, containing Mn₂O₃-based second electrode and aluminum salt-based electrolyte, pH=3. The cell was operated under constant current at 1 mA in the potential window of 0.1-1.6V.

FIG. 5A: Voltage profile and FIG. 5B: Cell life of asymmetric cell nanoAlMn_3b, containing Mn₂O₃-based second electrode, connected to a negative pole of the potentiostat, and aluminum salt-based electrolyte. The cell was operated under constant current at 1 mA in the potential window of 0.1-1.1V.

FIG. 6A: Voltage profile and FIG. 6B: Cell life of asymmetric cell nanoNaMn_3b, containing Mn₂O₃-based second electrode, connected to a negative pole of the potentiostat, and sodium salt-based electrolyte. The cell was operated under constant current at 1 mA in the potential window of 0.1-1.1V.

FIG. 7A: Voltage profile and FIG. 7B: Cell life of asymmetric cell nanoAlMn_3b, containing Mn₂O₃-based second electrode, connected to a negative pole of the potentiostat, and aluminum salt-based electrolyte. The cell was operated under constant current at 1 mA in the potential window of −0.1-(−1.1)V.

FIG. 8A: Voltage profile and FIG. 8B: Cell life of asymmetric cell nanoNaMn 3b, containing Mn₂O₃-based second electrode, connected to a negative pole of the potentiostat, and sodium salt-based electrolyte. The cell was operated under constant current at 1 mA in the potential window of −0.1-(−1.1)V.

FIG. 8C: Cell life of asymmetric cell AlSO4_MnO2_2a containing MnO₂-based second electrode and aluminum salt-based electrolyte, pH=3, connected to a positive pole of the potentiostat; asymmetric cell AlSO4_Mn2O3_7d containing Mn₂O₃-based second electrode and aluminum salt-based electrolyte, pH=3, connected to a positive pole of the potentiostat; asymmetric cell AlSO4_MnO2_3a containing MnO₂-based second electrode and aluminum salt-based electrolyte, pH=3; connected to a negative pole of the potentiostat, and asymmetric cell AlSO4_Mn2O3_8a containing Mn₂O₃-based second electrode and aluminum salt-based electrolyte, pH=3, connected to a negative pole of the potentiostat.

FIG. 9A: Voltage profile of asymmetric cell AlSulf_MoS2, containing MoS₂-based second electrode and an aluminum salt-based electrolyte and. The cell was operated under constant current at 10 mA in the potential window of 0.1-1.5V.

FIG. 9B: Cycle life of asymmetric cell AlSulf_MoS2, containing MoS₂-based second electrode and an aluminum salt-based electrolyte and. The cell was operated under different operating conditions.

FIG. 10A: Voltage profile and FIG. 10B: Cell life of asymmetric cell nanoMo4, containing MoS₂-based second electrode, connected to a negative pole of the potentiostat, and aluminum salt-based electrolyte. The cell was operated under constant current at 10 mA in the potential window of 0.1-1.5 V.

FIG. 11A: Voltage profile and FIG. 11B: Cell life of asymmetric cell nanoMo5, containing MoS₂-based second electrode, connected to a negative pole of the potentiostat, and sodium salt-based electrolyte. The cell was operated under constant current at 10 mA in the potential window of 0.1-1.5 V.

FIG. 12A: Voltage profile and FIG. 12B: Cell life of asymmetric cell nanoMo4, containing MoS₂-based second electrode, connected to a negative pole of the potentiostat, and aluminum salt-based electrolyte. The cell was operated under constant current at 10 mA in the potential window of −0.1-(−1.5)V.

FIG. 13A: Voltage profile and FIG. 13B: Cell life of asymmetric cell nanoMo5, containing MoS₂-based second electrode, connected to a negative pole of the potentiostat, and sodium salt-based electrolyte. The cell was operated under constant current at 10 mA in the potential window of −0.1-(−1.5)V.

### DETAILED DESCRIPTION OF THE INVENTION

The present invention is directed to a low-cost electrochemical energy storage device, which can be used for short-term, as well, as long-term energy storage applications and to the methods of construction thereof. The energy storage device according to the principles of the present invention can be configured to provide high power density (such as, for example, in the kW/kg range) and run for up to about 100 sec. Alternatively, the energy storage devices can be used for stationary applications, providing up to tens of hours of energy storage.

The energy storage devices of the present invention are based on electrochemical cells, including electrochemical capacitors or batteries. The electrochemical capacitors can be symmetric or asymmetric. The electrochemical cells of the present invention incorporate materials, which, according to the inventors' best knowledge, have not previously been used in the EC technology. The energy storage devices incorporating said electrochemical capacitors increase energy density of corresponding state-of-art ECs by 20% to about 100%. The energy storage devices according to the principles of the present invention also exhibited enhanced specific capacity and stable cycle life for thousands of cycles.

In some embodiments of the present invention the electrochemical cells include electrolytes containing post-transition trivalent ions, such as, for example, Al³⁺ or Ga³⁺. It was surprisingly found that such energy storage devices exhibited higher energy density (by about 37% for the symmetric ECs and by about 53% for the asymmetric ECs) and higher specific capacity (by about 34% for the symmetric ECs) than similar supercapacitors including a conventional monovalent ion (Na⁺) electrolyte. The increase in energy density and specific capacity was unexpected, inter alia, due to the lower conductivity and lower solubility of aluminum salts. Addition of post transition trivalent ions to the electrolyte is therefore an inexpensive way to increase specific capacity and energy density of the electrochemical capacitors, which can be implemented in the ECs having the conventional design and structure, including symmetric and asymmetric configurations.

Additional approach to increasing specific capacitance of the electrodes and energy density of the ECs included incorporation of precipitated salts of some post-transition metals or metalloids in pores of porous electrodes. It has been surprisingly found that the addition of said precipitated salts significantly increased the specific capacitance of the electrodes and energy density of the cells. Combination of the trivalent cation-based electrolyte and the electrodes containing precipitated salt provided an increase of about 65% in the energy density and of about 75% in the specific capacitance, as compared to the standard carbon electrodes and sodium salt electrolyte based symmetric EC.

According to some embodiments of the invention, the incorporation of the precipitated salt into the electrodes is performed by use of solutions. This can be seen as an additional advantage of the energy storage devices of the present invention and methods of their fabrication, since the use of metal or ceramic powders for incorporating into the electrodes for increasing their specific capacitance is avoided. Using solutions instead of micro- or nano-powders significantly reduced safety- and health-related hazards, associated with handling of said powders.

It has been further unexpectedly found by the inventors of the present invention that pyrite (FeS₂)—a chalcogenide, which was not previously reported as being useful in the EC technology, can be advantageously used as a transitional metal sulfide electrode material in asymmetric capacitors. Pyrite is the most common of the sulfide minerals and is an abundant and inexpensive material.

The present invention is therefore directed to the electrochemical storage devices and methods of their formation, incorporating the novel types of electrolytes, electrodes or combinations thereof, as explained in further detail hereinbelow.

Thus, according to a first aspect, the present invention provides an electrochemical energy storage device, comprising at least one electrochemical cell comprising a first porous electrode, a second porous electrode, an electrolyte being in contact with said first porous and second porous electrodes, and a porous separator separating the first porous electrode from the second porous electrode, wherein: (a) the electrolyte comprises a first dissolved salt comprising a trivalent post-transition metal cation; and/or (b) the first porous electrode, the second porous electrode or both electrodes comprise submicron particles of a precipitated salt comprising a cation selected from the group consisting of Pb²⁺, Sn²⁺, and Sb²⁺; and/or (c) the second porous electrode comprises pyrite (FeS₂) submicron particles.

The electrochemical cell may include an electrochemical capacitor or a battery. Each possibility represents a separate embodiment of the invention. In some embodiments, the battery does not include Al- or Al-ion battery. In further embodiments, the electrochemical cell does not include aluminum-based electrodes. In some embodiments, the battery does not include a lead-acid battery.

In certain embodiments, the electrochemical cell is an electrochemical capacitor. In further embodiments, the electrochemical energy storage device comprises at least one electrochemical capacitor comprising a first porous electrode, a second porous electrode, an electrolyte being in contact with said first porous and second porous electrodes, and a porous separator separating the first porous electrode from the second porous electrode, wherein: (a) the electrolyte comprises a first dissolved salt comprising a trivalent post-transition metal cation; and/or (b) the first porous electrode, the second porous electrode or both electrodes comprise submicron particles of a precipitated salt comprising a cation selected from the group consisting of Pb²⁺, Sn²⁺, and Sb²⁺; and/or (c) the second porous electrode comprises pyrite (FeS₂) submicron particles.

In some embodiments the electrochemical storage device according to the principles of the present invention further comprises at least one battery. The battery can be any type of battery, which can be used in conjunction with an electrochemical capacitor.

The terms “electrochemical capacitor”, “supercapacitor”, “ultracapacitor”, “capacitor”, “electrochemical capacitor cell” and “cell” are used interchangeably.

It is to be understood that the terms “electrochemical cell” and “electrochemical capacitor”, as used herein, encompass any type of an electrochemical energy storage cell, which includes two double-layer (DL) capacitance electrodes (e.g. high surface area carbon material-based electrode) or one DL capacitance electrode and one pseudocapacitance (also termed “active”) electrode, wherein the DL capacitance electrode stores charge through a reversible non-faradaic reaction of the electrolyte cations on the surface of the electrode (double-layer) and the pseudocapacitance electrode stores charge through a reversible redox faradaic reaction in a transition metal oxide or sulfide intercalated cation of the electrolyte. The electrochemical cell including two DL capacitance electrodes is termed in some embodiments “symmetric electrochemical capacitor”. The electrochemical cell including one DL capacitance electrode and one pseudocapacitance electrode, is termed in some embodiments “asymmetric electrochemical capacitor”.

In some embodiments, the term “electrochemical capacitor” refers to an energy storage cell, which stores charge only through a reversible non-faradaic reaction of the electrolyte cations and/or reversible redox faradaic reaction in a transition metal oxide or sulfide intercalated cation of the electrolyte. In further embodiments, the term “electrochemical capacitor” refers to an energy storage cell, which does not store energy in a chemical form. In still further embodiments, the term “electrochemical capacitor” refers to an energy storage cell which does not include electroactive redox couples, which are used in batteries, including flow batteries or fuel cells. In yet further embodiments, the term “electrochemical capacitor” refers to an energy storage cell which include electroactive redox couples at a concentration, which does not provide chemical energy storage.

In certain embodiments, the electrochemical cell is a battery.

The term “submicron particles”, as used herein, may encompass particles having a mean particle size in the range of from about 5 nm to about 5000 nm. The term “particle size”, as used in various embodiments of the invention refers to the length of the particle in the longest dimension thereof. The term “submicron particles” may further encompass nanoparticles.

The term “porous”, as used herein, refers to a structure of interconnected pores or voids such that continuous passages and pathways throughout a material are provided. In some embodiments, the porosity of the electrodes is from about 20% to about 90%, such as, for example, 30%-80%, or 40%-70% porosity. Each possibility represents a separate embodiment of the invention.

In some embodiments, the porous electrodes have a high surface area. The term “high surface area”, as used in some embodiments, refers to a surface area in the range from about 1 to about 2000 m²/g, such as, for example, 10-100 m²/g or 50-1500 m²/g.

In some embodiments, the terms “porous” and/or “high surface area” encompass materials having micro or nanoparticles.

The term “post-transition metal”, as used herein, refers to the metallic elements in the periodic table located between the transition metals (to their left) and the metalloids (to their right). Non-limiting examples of post-transitional metals include aluminum, gallium, indium, thallium, tin, lead, and bismuth.

The term “-valent”, as used herein refers to the maximum number of electrons available for covalent chemical bonding in its valence (outermost electron shell). For example, the term “trivalent”, as used in some embodiments, refers to a state of an atom with three electrons available for covalent chemical bonding in its outermost electron shell, and a the term “tetravalent”, as used in some embodiments, refers to a state of an atom with four electrons available for covalent chemical bonding in its outermost electron shell. It is to be understood, however, that the terms “trivalent” and “tetravalent” do not necessarily relate to the oxidation state of +3 and +4 respectively. Accordingly, a trivalent cation can be present in the oxidation state of +1, +2 or +3. A tetravalent cation can be present in the oxidation state of +1, +2, +3 or +4.

In some embodiments, the at least one electrochemical cell comprises a first porous electrode; a second porous electrode; an electrolyte comprising a first dissolved salt comprising a trivalent post-transition metal cation and being in contact with said first porous and second porous electrodes; and a porous separator separating the first porous electrode from the second porous electrode.

In some embodiments, the at least one electrochemical cell comprises a first porous electrode; a second porous electrode; wherein the first porous electrode, the second porous electrode or both electrodes comprise submicron particles of a precipitated salt comprising a cation selected from the group consisting of Pb²⁺, Sn²⁺, and Sb²⁺; an electrolyte being in contact with said first porous and second porous electrodes; and a porous separator separating the first porous electrode from the second porous electrode. According to some embodiments, the first porous electrode comprises said submicron particles of the precipitated salt. According to some embodiments, the second porous electrode comprises said submicron particles of the precipitated salt. According to further embodiments, the first and the second porous electrodes comprise said submicron particles of the precipitated salt.

In some embodiments, the at least one electrochemical cell comprises a first porous electrode; a second porous electrode, wherein the first porous electrode, the second porous electrode or both electrodes comprise submicron particles of a precipitated salt comprising a cation selected from the group consisting of Pb²⁺, Sn²⁺, and Sb²⁺; an electrolyte comprising a first dissolved salt comprising a trivalent post-transition metal cation and being in contact with said first porous and second porous electrodes; and a porous separator separating the first porous electrode from the second porous electrode. According to some embodiments, the first porous electrode comprises said submicron particles of the precipitated salt. According to some embodiments, the second porous electrode comprises said submicron particles of the precipitated salt. According to further embodiments, the first and the second porous electrodes comprise said submicron particles of the precipitated salt.

In some embodiments, the at least one electrochemical cell comprises a first porous electrode; a second porous electrode comprising FeS₂ submicron particles; an electrolyte being in contact with said first porous and second porous electrodes; and a porous separator separating the first porous electrode from the second porous electrode.

In some embodiments, the at least one electrochemical cell comprises a first porous electrode; a second porous electrode comprising FeS₂ submicron particles; an electrolyte comprising a first dissolved salt comprising a trivalent post-transition metal cation and being in contact with said first porous and second porous electrodes; and a porous separator separating the first porous electrode from the second porous electrode.

In some embodiments, the at least one electrochemical cell comprises a first porous electrode; a second porous electrode comprising FeS₂ submicron particles, wherein the first porous electrode, the second porous electrode or both electrodes further comprise submicron particles of a precipitated salt comprising a cation selected from the group consisting of Pb²⁺, Sn²⁺, and Sb²⁺; an electrolyte comprising a first dissolved salt comprising a trivalent post-transition metal cation and being in contact with said first porous and second porous electrodes; and a porous separator separating the first porous electrode from the second porous electrode.

Electrolyte

Electrolyte generally comprises a solvent and dissolved chemicals that dissociate into positive cations and negative anions, making the electrolyte electrically conductive. In electrochemical capacitors electrolytes are the electrically conductive connection between the first porous electrode and the second porous electrode. Additionally, in electrochemical capacitors the electrolyte provides the ions for the formation of the double-layer and delivers the ions for pseudocapacitance.

As mentioned hereinabove, in some embodiments, the energy storage device of the present invention comprises at least one electrochemical cell, which comprises an electrolyte, comprising a first dissolved salt comprising a trivalent post-transition metal cation. Without wishing to being bound by theory or mechanism of action, it is contemplated that the presence of the trivalent post-transition metal cations in the electrolyte increases specific capacitance and specific energy density of the ECs due to the higher positive charge of the trivalent ions as compared to the conventional monovalent ions.

Non-limiting examples of the trivalent post-transition metal cations include Al³⁺ and Ga³⁺. In certain embodiments, the trivalent post-transition metal cation is Al³⁺.

The electrolyte can include one dissolved salt or a combination of different dissolved salts. Thus, in some embodiments, the electrolyte includes a combination of trivalent post-transition metal salts.

In some embodiments, the electrolyte comprises a second dissolved salt. The second dissolved salt can be selected from an alkali metal salt, an alkali earth metal salt and combinations thereof. Each possibility represents a separate embodiment of the invention. The alkali metal salt can comprise a cation selected from the group consisting of Na⁺, K⁺, Li⁺ and combinations thereof. Each possibility represents a separate embodiment of the invention. In certain embodiments, the post-transition metal comprises Na⁺. In other embodiments, the post-transition metal comprises Li⁺.

The alkali earth metal salt can comprise a cation selected from the group consisting of Ca²⁺, Mg²⁺ Ba²⁺ and combinations thereof. Each possibility represents a separate embodiment of the invention.

According to some embodiments, the electrolyte comprises a combination of a trivalent post-transition metal salt and an alkali metal salt. Alternatively or additionally, the electrolyte can comprise a combination of a trivalent post-transition metal salt and an alkali earth metal salt. The electrolyte can further comprise a combination of a trivalent post-transition metal salt, an alkali metal salt and an alkali earth metal salt.

In other embodiments, the electrolyte comprises an alkali metal salt. In further embodiments, the electrolyte comprises a combination of an alkali metal salt and an alkali earth metal salt.

The electrolyte can further include tetravalent metal post-transition metal cations. Without wishing to being bound by theory or mechanism of action, the addition of minute amounts of a tetravalent post-transition metal cation to the electrolyte can reduce water decomposition (electrolysis) of an aqueous electrolyte and expand the operating voltage window of the EC. Thus, according to some embodiments, the electrolyte comprises a third dissolved salt comprising a tetravalent post-transition metal salt. The salt of the post-transition metal can comprise a cation selected from the group consisting of Pb²⁺, Sn²⁺ and combinations thereof. Each possibility represents a separate embodiment of the invention. In certain embodiments, the post-transition metal comprises Pb²⁺.

According to some embodiments, the electrolyte comprises a combination of a trivalent post-transition metal salt and tetravalent post-transition metal salt. According to further embodiments, the electrolyte comprises a combination of a trivalent post-transition metal salt, an alkali metal salt and a tetravalent post-transition metal salt. Alternatively or additionally, the electrolyte can comprise a combination of a trivalent post-transition metal salt, an alkali earth metal salt and a tetravalent post-transition metal salt. The electrolyte can further comprise a combination of a trivalent post-transition metal salt, an alkali metal salt, an alkali earth metal salt and a tetravalent post-transition metal salt.

In other embodiments, the electrolyte comprises a combination of an alkali metal salt and a tetravalent post-transition metal salt. In additional embodiments, the electrolyte comprises a combination of an alkali earth metal salt and a tetravalent post-transition metal salt. In further embodiments, the electrolyte comprises a combination of an alkali metal salt, an alkali earth metal salt and a tetravalent post-transition metal salt.

The first salt, the second salt, and/or the third salt comprise at least one anion. Said salts are present in the electrolyte in the dissolved state thereof. One skilled in the art can choose the suitable anion based, inter alia, on the solubility of the salt formed from said anion and a cation selected from a trivalent post-transition metal cation, an alkali metal cation, an alkali earth metal cation and a tetravalent post-transition metal cation, in an aqueous solution (either alkaline, acidic or essentially neutral) or organic solvent of the electrolyte. The anion should also be compatible (e.g. inert) with the electrode material. Non-limiting examples of suitable anions include sulfate, perchlorate, nitrate, methanesulfonate, trifluoromethanesulfonate, chloride, bromide, hydroxyl, bis(perfluoroethylsulfonyl)imide, carboxylate, acetate, and formate. The choice of the suitable anion can also be dictated by the presence of other cations in the electrolyte and/or electrodes of the ECs, and not only based on the nature of the cation of the salt to be dissolved in the electrolyte.

Concentration of the dissolved salt in the electrolyte can affect, inter alia, capacitance, resistance and operating voltage window of the electrochemical capacitor. According to some embodiments, the concentration of the first dissolved salt is in the range of from about 0.1M to about 10M. According to further embodiments, the concentration of the first dissolved salt is in the range of from about 0.5M to about 5M. According to still further embodiments, the concentration of the first dissolved salt is in the range of from about 1M to about 3M. In particular embodiments, the electrolyte comprises about 0.1M-10M Al³⁺ salt. In further embodiments, the electrolyte comprises about 0.5M-5M Al³⁺ salt. In still further embodiments, the electrolyte comprises about 1M-3M Al³⁺ salt.

According to some embodiments, the concentration of the second dissolved salt is in the range of from about 0.1M to about 10M. According to further embodiments, the concentration of the second dissolved salt is in the range of from about 0.5M to about 5M. According to still further embodiments, the concentration of the second dissolved salt is in the range of from about 1M to about 3M.

According to some embodiments, the total concentration of the first dissolved salt and the second dissolved salt is in the range of from about 0.1M to about 10M. According to further embodiments, the total concentration of the first dissolved salt and the second dissolved is in the range of from about 0.5M to about 5M. According to still further embodiments, the total concentration of the first dissolved salt and the second dissolved is in the range of from about 1M to about 3M.

According to some embodiments, the concentration of the third dissolved salt is in the range of from about 0.0001M to about 1M. According to further embodiments, the concentration of the third dissolved salt is in the range of from about 0.0001M to about 0.1M. According to still further embodiments, the concentration of the third dissolved salt is in the range of from about 0.001M to about 0.05M.

The energy storage devices according to the principles of the present invention can include aqueous-based or organic solvent-based electrochemical capacitors.

Thus, in some embodiments, the electrolyte is an aqueous-based electrolyte. Water is a relatively good solvent for inorganic chemicals, including various Al salts. According to some embodiments, aqueous-based electrolyte includes an acid or a base, to increase conductivity of the electrolyte. Non-limiting examples of the suitable acids include sulfuric acid (H₂SO₄), hydrochloric acid (HCl), nitric acid (HNO₃), metanesulfonic acid (MSA, CH₃SO₃H) or tetrafluoroboric acid (HBF₄). Non-limiting examples of the suitable bases include potassium hydroxide (KOH), sodium hydroxide (NaOH), and lithium oxide (LiOH). According to some embodiments, the pH of the electrolyte is in the range of about 0 to 14 or 0 to 7 or 7 to 14 depending on the compatibility of the electrolyte and the electrode with the electrolyte.

In other embodiments, the electrolyte is an organic solvent-based electrolyte. Electrolytes with organic solvents are more expensive than aqueous electrolytes, but they provide a wider operating voltage window than aqueous-based electrolytes. It is to be understood that any organic electrolyte capable of dissolving the first salt, the second salt and/or the third salt are encompassed within the scope of the present invention. The organic solvent can be selected from a cyclic carbonate, a linear carbonate, a linear formate, an ether-based organic solvent, an ionic liquid, and combinations thereof. Each possibility represents a separate embodiment of the invention. Non-limiting examples of the organic solvents include ethylene carbonate (EC), propylene carbonate (PC), diethyl carbonate (DEC), dimethyl carbonate (DMC), ethyl formate (EF), methyl formate (MF), 1-ethyl-3-methylimidazolium bis (trifluoromethylsulfonyl)imide, 1-ethyl-3-methylimidazolium trifluoromethanesulfonate, 1-hexyl-3-methylimidazolium hexafluorophosphate, 1-ethyl-3-methylimidazolium dicyanamide, and 11-methyl-3-octylimidazolium tetrafluoroborate.

The electrolyte can be a liquid or a gel-based electrolyte. Each possibility represents a separate embodiment of the invention.

The electrolyte can further include additives, configured to minimize dissolution of the second porous electrode material in asymmetric ECs. In further embodiments, said electrolyte additives are configured to suppress gas evolution on the first and/or the second electrodes. Non-limiting examples of said electrolyte additives include Pb, Sn and Ga species.

Electrodes

The electrodes suitable for use in the electrochemical cells of the present invention can include any conductive porous material. In some embodiments said porous material is a high surface area material. In some embodiments, the electrodes include a high surface area conductive powder. In some embodiments, the high surface area conductive powder is referred to as “active mass” of the electrode. The surface area of said powder can be in the range of from about 1 to about 2000 m²/g, such as from about 10 to about 100 m²/g or from about 50 to about 1500 m²/g. Each possibility represents a separate embodiment of the invention. The high surface area conductive powder can comprise micro- or nanoparticles. The size of said microparticles can be in the range of from about 0.1 to about 10 μm. The size of said nanoparticles can be in the range of from about 100 to about 1000 nm. According to some currently preferred embodiments, the high surface area conductive powder comprises nanoparticles. The high-surface conductive powder can be selected, inter alia, from a high surface area carbon material, a metal oxide or a metal sulfide.

According to some embodiments, the first porous electrode comprises a high surface area carbon material. According to some embodiments, the second porous electrode comprises a high surface area carbon material. Non-limiting examples of the high surface area carbon material include carbon, graphite, carbon nanotubes, and graphene. Said carbon based materials can be treated by a chemical or physical process in order to increase the active surface area thereof. In certain embodiments, the high surface area material is carbon. Carbon can include activated carbon. The surface area of the high surface area carbon material can range from 1 to about 2000 m²/g, from about 10 to about 100 m²/g or from about 50 to about 1500 m²/g.

According to some embodiments, the electrochemical cell is a symmetric electrochemical capacitor. In certain such embodiments, the first porous electrode and the second porous electrode comprise the high surface area carbon material. In certain embodiments, the first porous electrode and the second porous electrode consist essentially of the high surface area carbon material. As used herein the term “consisting essentially” relates to the high surface area conductive powder component of the electrode. According to further embodiments, the first porous electrode comprises from about 1% to about 100% w/w high surface area carbon material, such as, for example, 5% w/w-95% w/w, 10% w/w-80% w/w, 20% w/w-70% w/w, or 30 w/w-60% w/w high surface area carbon material. According to yet further embodiments, the second porous electrode comprises 1% to about 100% w/w high surface area carbon material, such as, for example, 5% w/w-95% w/w, 10% w/w-80% w/w, 20% w/w-70% w/w, or 30 w/w-60% w/w high surface area carbon material.

According to some embodiments, the first porous electrode comprises a transition metal oxide or sulfide. According to some embodiments, the second porous electrode comprises a transition metal oxide or sulfide. Each possibility represents a separate embodiment of the invention. Non-limiting examples of transition metal oxides or sulfides include MnₙOₓ TiOₓ, NiOₓ, CoOₓ, SnOₓ, FeS_{y}, MoS_{y}, NiS_{y}, CoS_{y}, MnS_{y}, TiS_{y}, SnS_{y}, CrₙOₓ, VnOₓ, CuₙOₓ, ZrOₓ, NbₙOₓ, WₙOₓ, MoOₓ and combinations thereof, wherein x ranges from 1.5 to 3, y ranges from 1.8 to 2.2 and n ranges from 1 to 2. In some embodiments, the first porous electrode comprises MnₙOx. In other embodiments, the first porous electrode comprises MoS_{y}. In some embodiments, the second porous electrode comprises MnₙOₓ. In other embodiments, the second porous electrode comprises MoS_{y}. MnₙOₓ can include, inter alia, MnO₂ and Mn₂O₃. The non-limiting example of MoS_{y} is MoS₂.

In some embodiments, the first porous electrode comprises FeS₂ submicron particles. In some embodiments, the second porous electrode comprises FeS₂ submicron particles. In further embodiments, FeS₂ submicron particles have a surface area of from about 1 to about 2000 m²/g, such as, for example 10-100 m²/g or 50-1500 m²/g. The mean particle size of FeS₂ submicron particles can be in the range from about 5 to about 5000 nm, such as, for example, 50-1000 nm or 100-500 nm.

According to some embodiments, the electrochemical cell is a symmetric electrochemical capacitor. In certain such embodiments, the first porous electrode and the second porous electrode comprise the high surface area carbon material. In some embodiments, the second porous electrode comprises from about 0.001% w/w to about 10% w/w transition metal oxide or sulfide. In certain embodiments, the transition metal oxide is MnₙOₓ. Without wishing to being bound by theory or mechanism of action, addition of minute amounts of a transition metal oxide or sulfide to the second porous electrode of the symmetric EC reduces water decomposition (electrolysis) of the aqueous-based electrolyte and expands operating voltage window.

According to some embodiments, the electrochemical cell is a symmetric electrochemical capacitor. In certain such embodiments, the first porous electrode and the second porous electrode comprise transition metal oxide or sulfide. In certain such embodiments, the first porous electrode and the second porous electrode comprise the same transition metal oxide or sulfide. According to some embodiments, the first porous electrode and the second porous electrode comprise from about 50% w/w to about 99% w/w transition metal oxide or sulfide. According to further embodiments, the first porous electrode and the second porous electrode comprise from about 60% w/w to about 99% w/w transition metal oxide or sulfide. According to still further embodiments, the first porous electrode and the second porous electrode comprise from about 70% w/w to about 99% w/w transition metal oxide or sulfide. According to further embodiments, the first porous electrode and the second porous electrode comprise from about 80% w/w to about 99% w/w transition metal oxide or sulfide. According to yet further embodiments, the first porous electrode and the second porous electrode comprise from about 90% w/w to about 99% w/w transition metal oxide or sulfide. In further embodiments, the first porous electrode and the second porous electrode consist essentially of the transition metal oxide or sulfide. In particular embodiments, the first porous electrode and the second porous electrode comprise a combination of the high surface area carbon material and the transition metal oxide or sulfide. According to some embodiments, the first porous electrode and the second porous electrode comprise from about 1% w/w to about 50% w/w high surface area carbon material. According to further embodiments, the first porous electrode and the second porous electrode comprise from about 1% w/w to about 40% w/w high surface area carbon material. According to still further embodiments, the first porous electrode and the second porous electrode comprise from about 1% w/w to about 30% w/w high surface area carbon material. According to yet further embodiments, the first porous electrode and the second porous electrode comprise from about 1% w/w to about 20% w/w high surface area carbon material. According to still further embodiments, the first porous electrode and the second porous electrode comprise from about 1% w/w to about 10% w/w high surface area carbon material. In certain embodiments, the transition metal oxide is MnₙOₓ. The transition metal sulfide can be selected from MoS_{y} and FeS₂. Each possibility represents a separate embodiment of the invention.

According to some embodiments, the electrochemical cell is an asymmetric electrochemical capacitor. In certain such embodiments, the first porous electrode comprises the high surface area carbon material and the second porous electrode comprises the transition metal oxide or sulfide. According to some embodiments, the second porous electrode comprises from about 50% w/w to about 99% w/w transition metal oxide or sulfide. According to further embodiments, the second porous electrode comprises from about 60% w/w to about 99% w/w transition metal oxide or sulfide. According to still further embodiments, the second porous electrode comprises from about 70% w/w to about 99% w/w transition metal oxide or sulfide. According to further embodiments, the second porous electrode comprises from about 80% w/w to about 99% w/w transition metal oxide or sulfide. According to yet further embodiments, the second porous electrode comprises from about 90% w/w to about 99% w/w transition metal oxide or sulfide. In further embodiments, the first porous electrode and the second porous electrode consist essentially of the transition metal oxide or sulfide. In particular embodiments, the second electrode comprises a combination of the high surface area carbon material and the transition metal oxide or sulfide. According to some embodiments, the second porous electrode comprises from about 1% w/w to about 50% w/w high surface area carbon material. According to further embodiments, the second porous electrode comprises from about 1% w/w to about 40% w/w high surface area carbon material. According to still further embodiments, the second porous electrode comprises from about 1% w/w to about 30% w/w high surface area carbon material. According to yet further embodiments, the second porous electrode comprises from about 1% w/w to about 20% w/w high surface area carbon material. According to still further embodiments, the second porous electrode comprises from about 1% w/w to about 10% w/w high surface area carbon material.

According to some embodiments, the first porous electrode comprises the high surface area carbon material and the second porous electrode comprises FeS₂. In particular embodiments, the second electrode comprises a combination of the high surface area carbon material and FeS₂. According to some embodiments, the second porous electrode comprises from about 50% w/w to about 99% w/w transition metal oxide or sulfide. In further embodiments, the second porous electrode comprises from about 60% w/w to about 90% w/w FeS₂. In certain embodiments, the second porous electrode comprises about 75% w/w FeS₂.

According to some embodiments, the electrochemical cell is an asymmetric electrochemical capacitor. In certain such embodiments, the first porous electrode comprises a transition metal oxide or sulfide and the second porous electrode comprises a transition metal oxide or sulfide, which is different from the transition metal oxide or sulfide of the first porous electrode. According to some embodiments, the first porous electrode and the second porous electrode comprise from about 50% w/w to about 99% w/w transition metal oxide or sulfide. According to further embodiments, the first porous electrode and the second porous electrode comprise from about 60% w/w to about 99% w/w transition metal oxide or sulfide. According to still further embodiments, the first porous electrode and the second porous electrode comprise from about 70% w/w to about 99% w/w transition metal oxide or sulfide. According to further embodiments, the first porous electrode and the second porous electrode comprise from about 80% w/w to about 99% w/w transition metal oxide or sulfide. According to yet further embodiments, the first porous electrode and the second porous electrode comprise from about 90% w/w to about 99% w/w transition metal oxide or sulfide. In further embodiments, the first porous electrode and the second porous electrode consist essentially of the transition metal oxide or sulfide. In particular embodiments, the first porous electrode and the second porous electrode comprise a combination of the high surface area carbon material and the transition metal oxide or sulfide. According to some embodiments, the first porous electrode and the second porous electrode comprise from about 1% w/w to about 50% w/w high surface area carbon material. According to further embodiments, the first porous electrode and the second porous electrode comprise from about 1% w/w to about 40% w/w high surface area carbon material. According to still further embodiments, the first porous electrode and the second porous electrode comprise from about 1% w/w to about 30% w/w high surface area carbon material. According to yet further embodiments, the first porous electrode and the second porous electrode comprise from about 1% w/w to about 20% w/w high surface area carbon material. According to still further embodiments, the first porous electrode and the second porous electrode comprise from about 1% w/w to about 10% w/w high surface area carbon material. In some embodiments, the first porous electrode comprises a transition metal oxide and the second porous electrode comprises a transition metal sulfide. The metal atoms of the transition metal sulfide and the transition metal may be same or different. Each possibility represents a separate embodiment of the invention. In particular embodiments, the first porous electrode comprises MoS_{y} and the second porous electrode comprises MnₙOₓ. In certain such embodiments, the first electrode is a negative electrode and a second electrode is a negative electrode.

In electrochemical cells incorporating metal oxides or sulfides, the transition metal oxides and sulfides can be used in a positive electrode that adsorbs anions on charge or a negative electrode that adsorbs cations on charge. For example the +4 oxidation state metal, such as, for example, MnO₂ (or any MO₂ transition metal (M) oxide) is better used as a negative electrode for adsorption of cations on charge and the +3 oxidation state transition metal, such as, for example Mn₂O₃ (or any M₂O₃ transition metal (M) oxide) is better used as a positive electrode which adsorbs anions on charge. Without wishing to being bound by theory or mechanism of action, it is contemplate that on charge the oxidation state of M of the positive electrode rises from 3 to 3+z (where z is smaller than 1) and anions from the electrolyte adsorb on its surface and possibly under the surface of the transition metal particles and cations de-intercalate from the electrode. It is further contemplated without being bound by theory, that on charge the oxidation state of M of the negative electrode decreases from 4 to 4-z (where z is smaller than 1) and cations from the electrolyte adsorb on its surface and possibly under the surface of the particles of the electrode (intercalation). The increase in the electrochemical cell capacitance shown by the inventors of the present invention when using a trivalent post-transition metal cation instead of a monovalent cation in the electrolyte in a cell configuration, where a transition metal oxides and sulfides are used as a positive electrode that adsorbs anions on charge, is therefore even more surprising. More than 100% increase in the electrode capacitance was found for the MnₙOₓ and MoS₂ positive electrodes.

Thus, according to some embodiments, the first porous electrode is a negative electrode (i.e. an anode) and the second porous electrode is a positive electrode (i.e. a cathode). According to further embodiments, the first electrode is configured to adsorb cations during charge of the electrochemical cell and the second electrode is configured to adsorb anions during charge.

In some embodiments, the porous electrodes of the present invention do not include electroactive redox species other than the transition metal oxide or sulfide, the cations of the electrolyte or the precipitated salts of Pb²⁺, Sn²⁺, and Sb²⁺.

Electrodes Including Submicron Particles of Precipitated Salt

As mentioned hereinabove, the present invention encompasses electrochemical cells which contain submicron particles of precipitated salt in their porous electrodes. The precipitated salt can include a cation, which during charge undergoes reduction at the first electrode and oxidation at the second electrode. Without wishing to being bound by theory or mechanism of action, it is contemplated that the addition of the nanometric precipitated salt of Pb²⁺, Sn²⁺, or Sb²⁺ increases specific energy density and capacitance of the electrochemical capacitors due to the additional Faradaic reactions taking place on or in a close proximity to the electrodes. Particularly, in the case of precipitated PbSO₄ salt, a reaction according to Formula (1) can take place on the first porous electrode:

PbSO₄(s)+2e⁻+2H⁺→Pb(s)+H₂SO₄(aq) Formula (I)

And a reaction according to Formula (II) can take place on the second porous electrode:

PbSO₄(s)+2H₂O→PbO₂(s)+2e−+2H⁺+H₂SO₄(aq) Formula (II)

These reversible reactions take place in the common lead acid battery and when running the battery at low depth of discharge, many thousands of cycles are achieved.

Thus, according to some embodiments, the first porous electrode, the second porous electrode or both electrodes comprise the submicron particles of the precipitated salt comprising a cation selected from the group consisting of Pb²⁺, Sn²⁺, and Sb²⁺. Each possibility represented a separate embodiment of the invention. According to some embodiments, the submicron particles of the precipitated salt are deposited in the pores of the first porous electrode and/or of the second porous electrode. According to dome embodiments, the submicron particles are homogeneously distributed within the pores of the first porous electrode and/or the second porous electrode. As used herein, the term “homogeneously distributed” denotes that the volume percentage of the submicron particles of the precipitated salt varies from one position on the electrode to another by less than about 40%, less than about 20% or less than 10%. Each possibility represents a separate embodiment of the invention.

The precipitated salt can comprise an anion selected from sulfate, carbonate and chloride. Each possibility represents a separate embodiment of the invention. In certain embodiments, the anion is sulfate.

According to some embodiments, the weight of the submicron particles of the precipitated salt is from about 0.001% to about 70% of the total weight of the electrode, such as, for example, 0.01%-1%, 1%-5%, 5%-10%, 10%-20%, 20%-30%, 30%-40%, 40%-50%, 50%-60% or 60%-70%. In other embodiments, the weight of the submicron particles of the precipitated salt is about 5%-50% or 10%-40% of the total weight of the electrode. In some experimental embodiments, the weight of the submicron particles of the precipitated salt is from about 15% to about 30% of the total weight of the electrode.

The mean particle size of submicron particles of the precipitated salt can be in the range from about 5 to about 5000 nm, such as, for example, 50-1000 nm or 100-500 nm.

As mentioned hereinabove, in some embodiments, the cation of the precipitated salt is reduced to metallic state on the first porous electrode and/or is oxidized to a metal oxide on the second porous electrode during potential cycling of the device. Each possibility represents a separate embodiment of the invention. In certain such embodiments, the first porous electrode can comprise submicron particles of a metal selected from the group consisting of Pb, Sn, and Sb. In further embodiments, the second porous electrode comprises submicron particles of a metal oxide selected from the group consisting of PbO₂, SnO₂, and SbO₂. In yet further embodiments, the submicron particles of the metal or of the metal oxide are deposited in the pores of the first porous electrode and/or of the second porous electrode.

According to some embodiments, the electrochemical cell is a symmetric electrochemical capacitor. In some embodiments, the first porous electrode and the second porous electrode comprise the high surface area carbon material and further comprise the precipitated salt. In other embodiments, the first porous electrode and the second porous electrode comprise the high surface area carbon material and the second porous electrode further comprises the precipitated salt.

According to some embodiments, the electrochemical cell is an asymmetric electrochemical capacitor. In some embodiments, the first porous electrode comprises the high surface area carbon material and the precipitated salt and the second porous electrode comprises the transition metal oxide or sulfide and the precipitated salt. In other embodiments, the first porous electrode comprises the high surface area carbon material and the second porous electrode comprises the transition metal oxide or sulfide and the precipitated salt.

In some embodiments, the high surface area conductive powder is deposited on a conductive support. According to some embodiments, said conductive support is porous. Non-limiting example of conductive supports include carbon paper, carbon felt, carbon-plastic conductive composites, thin metal, including nickel, stainless steel, matrix, sponge or felt. The thin metal support can have a thickness of about 0.05 to 5 mm.

A typical loading of the high surface area conductive powder on the conductive support is in the range of about 1 to about 20 mg/cm². According to some embodiments, the loading of a high surface area carbon material on the conductive support is in the range of about 10 to about 20 mg/cm². According to some embodiments, the loading of a metal oxide or sulfide on the conductive support is in the range of about 1 to about 20 mg/cm². According to certain embodiments, the loading of FeS₂ on the conductive support is in the range of about 1 to about 5 mg/cm².

According to some embodiments, the first porous electrode and/or the second porous electrode comprise a high surface area conductive powder deposited on a conductive support. Each possibility represents a separate embodiment of the invention.

In some embodiments, the high surface area conductive powder is deposited on a conductive support by means of a binder. Thus, in some embodiments, the first porous electrode and/or the second porous electrode comprise a high surface area conductive powder mixed with a binder and deposited on a conductive support. In some embodiments said binder is a polymeric binder, which is compatible with the electrode and electrolyte components. Non-limiting examples of a binder include carboxymethyl cellulose (CMC), rubbers, PVDF, Teflon, LiPAA The typical weight of the binder is about 2% to about 20%, preferably 5-15% of the total weight of the electrode.

Porous Separator

The separator can be formed of any suitable separating material having high porosity and ionic permeability that is electrochemically stable and that is electronically nonconductive.

In some embodiments, the separator comprises an ion selective membrane that selectively slows the transport of some electrolyte components and/or accelerates the transport of other electrolyte components through the separator. Examples of suitable separator materials are glass separators, ion conducting membranes, proton exchange membranes (PEMs), proton conducting membranes (PCMs), and nanoporous PCMs (NP-PCMs). NP-PCMs are described in a paper titled “A novel proton-conducting membrane” by E. Peled, T. Duvdevani, and A. Melman, Electrochemical and Solid-State Letters, 1 (5), (1998) 210-211, which is incorporated herein by reference in its entirety.

In some embodiments, the separator is in contact with the electrolyte or combination of electrolytes as described above. In a particular embodiment, the separator is impregnated with the electrolyte or combination of electrolytes as described above.

Aluminum Cation-Containing Symmetric Electrochemical Capacitors

In certain embodiments the present invention provides a device comprising at least one electrochemical capacitor, wherein the first porous electrode comprises the high surface area carbon material, the second porous electrode comprises the high surface area carbon material and the electrolyte is aqueous based and comprises dissolved Al³⁺ salt. According to further embodiments, the anion of the dissolved Al³⁺ salt is selected from the group consisting of sulfate, nitrate, and methanesulfonate. The concentration of the dissolved Al³⁺ salt can be in the range of about 0.1M to about 5M.

According to further embodiments, the electrolyte further comprises the dissolved alkali metal salt. In particular embodiments, the dissolved alkali metal salt is a Na⁺ salt. The concentration of the dissolved alkali metal salt can be in the range of about 0.1M to about 5M.

According to further embodiments, the electrolyte further comprises the dissolved tetravalent post-transition metal salt. According to still further embodiments, the dissolved tetravalent post-transition metal salt is a Pb²⁺ salt. The concentration of the dissolved tetravalent post-transition metal salt can be in the range of about 0.0001M to about 0.1M.

According to further embodiments, the first porous electrode and the second porous electrode comprise the precipitated Pb²⁺ salt, which is deposited in the pores of said porous electrodes. According to still further embodiments the precipitated Pb²⁺ salt is a PbSO₄ salt.

Aluminum Cation-Containing Asymmetric Electrochemical Capacitors

In certain embodiments the present invention provides a device comprising at least one electrochemical capacitor, wherein the first porous electrode comprises the high surface area carbon material, the second porous electrode comprises the transition metal oxide and the electrolyte is aqueous based and comprises dissolved Al³⁺ salt. The dissolved Al³⁺ salt can be Al₂(SO₄)₃. According to further embodiments, the concentration of the dissolved Al³⁺ salt is in the range of about 0.1M to about 5M.

According to further embodiments, the electrolyte further comprises the dissolved alkali metal salt. The dissolved alkali metal salt can be a Na⁺ salt. According to further embodiments, the concentration of the dissolved alkali metal salt is in the range of about 0.1M to about 5M.

According to further embodiments, the electrolyte further comprises the dissolved tetravalent post-transition metal salt. The dissolved tetravalent post-transition metal salt can be a Pb²⁺ salt. According to further embodiments, the concentration of the dissolved tetravalent post-transition metal salt is in the range of about 0.0001M to about 0.1M.

According to further embodiments, the transition metal oxide is MnₙOₓ. MnₙOₓ can be selected from MnO₂ and Mn₂O₃. In still further embodiments the transition metal sulfide is MoS₂ or FeS₂. Each possibility represents a separate embodiment of the invention. According to some embodiments, the second electrode further comprises the high surface area carbon material.

According to further embodiments, the first porous electrode and the second porous electrode comprise the precipitated Pb²⁺ salt, which is deposited in the pores of said porous electrodes. According to still further embodiments the precipitated Pb²⁺ salt is a PbSO₄ salt.

In the currently preferred embodiments, the second porous electrode is a positive electrode.

Precipitated Salt-Containing Symmetric Electrochemical Capacitors

In certain embodiments the present invention provides a device comprising at least one electrochemical capacitor, wherein the first porous electrode and the second porous electrode comprise the high surface area carbon material and the submicron particles of the precipitated salt comprising a cation selected from the group consisting of Pb²⁺, Sn²⁺, and Sb²⁺, wherein the submicron particles are deposited in the pores of said electrodes. According to further embodiments, the precipitated salt comprises an anion selected from the group consisting of sulfate, carbonate and chloride. According to particular embodiments, the precipitated salt comprises a PbSO₄ salt. According to further embodiments, the first porous electrode further comprises Pb submicron particles and the second porous electrode further comprises PbO₂ submicron particles. According to yet further embodiments, the electrolyte is aqueous-based and comprises at least one cation selected from the group consisting of Na⁺, K⁺, Li⁺, Ca²⁺, Mg²⁺, Ba²⁺, Al³⁺, and Ga³⁺, and further comprises at least one anion selected from the group consisting of a sulfate, perchlorate, nitrate, methanesulfonate, trifluoromethanesulfonate, chloride, bromide, hydroxyl, bis(perfluoroethylsulfonyl)imide, carboxylate, acetate and formate. In particular embodiments, the electrolyte comprises an Al³⁺ cation and a sulfate anion.

Precipitated Salt-Containing Asymmetric Electrochemical Capacitors

In certain embodiments the present invention provides a device comprising at least one electrochemical capacitor, wherein the first porous electrode comprises the high surface area carbon material and the second porous electrode comprises the metal oxide or sulfide and wherein the first electrode and the second electrode further comprise the submicron particles of the precipitated salt comprising a cation selected from the group consisting of Pb²⁺, Sn²⁺, and Sb²⁺, wherein the submicron particles are deposited in the pores of said electrodes. According to further embodiments, the precipitated salt comprises an anion selected from the group consisting of sulfate, carbonate and chloride. According to particular embodiments, the precipitated salt comprises a PbSO₄ salt. According to further embodiments, the first porous electrode further comprises Pb submicron particles and the second porous electrode further comprises PbO₂ submicron particles. According to yet further embodiments, the electrolyte is aqueous-based and comprises at least one cation selected from the group consisting of Na⁺, K⁺, Li⁺, Ca²⁺, Mg²⁺, Ba²⁺, Al³⁺, and Ga³⁺, and further comprises at least one anion selected from the group consisting of a sulfate, perchlorate, nitrate, methanesulfonate, trifluoromethanesulfonate, chloride, bromide, hydroxyl, bis(perfluoroethylsulfonyl)imide, carboxylate, acetate and formate. In particular embodiments, the electrolyte comprises an Al³⁺ cation and a sulfate anion.

According to further embodiments, the transition metal oxide is MnₙOₓ wherein x ranges from 1 to 3 and n ranges from 1 to 2. In still further embodiments the transition metal sulfide is MoS₂ or FeS₂. Each possibility represents a separate embodiment of the invention.

Pyrite-Containing Asymmetric Electrochemical Capacitors

In certain embodiments the present invention provides a device comprising at least one electrochemical capacitor, wherein the first porous electrode comprises the high surface area carbon material and the second porous electrode comprises FeS₂ submicron particles. In some embodiments, FeS₂ submicron particles have a surface area of from about 1 to about 2000 m²/g. The mean particle size of FeS₂ submicron particles can be in the range from about 5 to about 5000 nm. In some embodiments, the second porous electrode further comprises the high surface area carbon material. In further embodiments, the electrolyte is aqueous-based and comprises at least one cation selected from the group consisting of Na⁺, K+, Li⁺, Ca²⁺, Mg²⁺, Ba²⁺, Pb²⁺, Sb²⁺, Sb²⁺, Al³⁺, and Ga³⁺, and at least one anion selected from the group consisting of a sulfate, perchlorate, nitrate, methanesulfonate, trifluoromethanesulfonate, chloride, bromide, hydroxyl, bis(perfluoroethylsulfonyl)imide, carboxylate, acetate and formate. In particular embodiments, the electrolyte comprises at least one cation selected from Na⁺, Li⁺, and Al³⁺.

Energy Storage Devices

According to some embodiments, the at least one electrochemical cell further comprises a first porous electrode current collector and a second porous electrode current collector. The current collector can comprise an inert conducting material, such as, but not limited to, composite carbon, composite graphite, stainless steel or nickel.

According to further embodiments, the at least one electrochemical capacitor is sealed in a case. The case can have an outlet, configured to release gas, which evolves during the operation of the device. Additionally or alternatively, the at least one electrochemical cell can include an oxygen-hydrogen recombination catalyst, to eliminate or reduce pressure of the evolved gas.

The energy storage device of the present invention can include a plurality of electrochemical cells to provide the desired level of capacity and/or energy density. According to some embodiments, the device according to the principles of the present invention comprises from about 2 to about 10000 electrochemical cells connected in series and/or in parallel. In certain embodiments, the device comprises from about 10 to about 1000 electrochemical cells. In other embodiments, the device comprises from about 100 to about 300 electrochemical cells. In particular embodiments, the electrochemical cell is an electrochemical capacitor.

According to further embodiments, the plurality of electrochemical cells is configured in a stack. The stack can have an outlet, configured to release gas, which evolves during the operation of the device.

According to various embodiments, the device according to the principles of the present invention is configured to provide capacity for operation for up to about 100 sec.

According to various embodiments, the device according to the principles of the present invention, is configured to provide capacity for operation for from about 100 sec to about 200 h.

According to various embodiments, the device according to the principles of the present invention, is configured to provide specific energy density of from about 1 to about 50 Wh/kg (of the electrode active mass).

In additional embodiments, the device according to the principles of the present invention, is configured to be stable for at least about 1,000 cycles. In further embodiments, the device is configured to be stable for at least about 1,000 cycles, 3,000 cycles, 10,000 cycles, 50,000 or even 100,000 cycles. The term “stable”, as used herein, relates to the degradation in the performance of the device (e.g. reduction in the energy density), which is less than about 50%.

Methods of Forming of the Energy Storage Devices

The present invention further provides methods for forming an electrochemical energy storage device, comprising at least one electrochemical cell, wherein the at least one electrochemical cell can comprise a trivalent post-transition metal salt in the electrolyte thereof; submicron particles of a precipitated salt in the electrodes thereof, and/or pyrite-based electrode. In some embodiments, the methods for forming the energy storage device include combining a plurality of said electrochemical cells, to provide the desired level of capacity and/or energy density.

Methods of Forming of the Electrochemical Cells Containing Trivalent Metal Cations in the Electrolyte

In another aspect, the present invention provides a method for forming an electrochemical energy storage device comprising at least one electrochemical cell, the method comprising: (a) forming a first porous electrode and a second porous electrode; (b) separating the first porous electrode from the second porous electrode by a porous separator; (c) forming an electrolyte, comprising dissolving a first salt comprising a trivalent post-transition metal cation in water or in an organic solvent; and (d) filling the separator with the electrolyte, wherein the electrolyte in contact with the first porous electrode and with the second porous electrode.

According to some embodiments, the trivalent post-transition metal cation is selected from the group consisting of Al³⁺, Ga³⁺ and a combination thereof. Each possibility represents a separate embodiment of the invention

According to some embodiments, the method comprises dissolving a second salt selected from the group consisting of an alkali metal salt, an alkali earth metal salt and combinations thereof. The salt of the alkali metal can comprise at least one cation selected from the group consisting of Na⁺, K⁺, and Li⁺. The salt of the alkali earth metal can comprise at least one cation selected from the group consisting of Ca²⁺, Mg²⁺ and Ba²⁺. Each possibility represents a separate embodiment of the invention

According to further embodiments, the method comprises dissolving a third salt comprising a tetravalent post-transition metal salt. The salt of the post-transition metal can comprise at least one cation selected from Pb²⁺ or Sn²⁺. Each possibility represents a separate embodiment of the invention

In some embodiments, the first salt, the second salt, and/or the third salt comprises at least one anion selected from the group consisting of a sulfate, perchlorate, nitrate, methanesulfonate, trifluoromethanesulfonate, chloride, bromide, hydroxyl, bis(perfluoroethylsulfonyl)imide, carboxylate, acetate and formate.

In some embodiments, the electrolyte is aqueous-based.

In some embodiments, the electrolyte is organic solvent-based. In further embodiments, the organic solvent is selected from the group consisting of ethylene carbonate (EC), propylene carbonate (PC), diethyl carbonate (DEC), dimethyl carbonate (DMC), ethyl formate (EF), methyl formate (MF), 1-ethyl-3-methylimidazolium bis (trifluoromethylsulfonyl)imide, 1-ethyl-3-methylimidazolium trifluoromethanesulfonate, 1-hexyl-3-methylimidazolium hexafluorophosphate, 1-ethyl-3-methylimidazolium dicyanamide, 11-methyl-3-octylimidazolium tetrafluoroborate and combinations thereof.

The step of forming a first porous electrode and a second porous electrode involves the use of a high surface area material, including carbon-based material and transition metal oxides and sulfides. According to some embodiments, the first porous electrode and/or the second porous electrode comprise a high surface area carbon material, selected from the group consisting of carbon, graphite, carbon nanotubes, graphene, and combinations thereof. Each possibility represents a separate embodiment of the invention.

According to some embodiments, the first and/or the second porous electrode comprise a transition metal oxide or sulfide, selected from the group consisting of MnₙOx, TiOx, NiOx, CoOx, SnOx, FeS_{y}, MoS_{y}, NiS_{y}, CoS_{y}, MnS_{y}, TiS_{y}, SnS_{y} and combinations thereof, wherein x ranges from 1.5 to 3, y ranges from 1.8 to 2.2 and n ranges from 1 to 2. In some embodiments, the first porous electrode and/or the second porous electrode comprise a combination of the high surface area carbon and the transition metal oxide or sulfide.

According to some embodiments, the step of forming a first porous electrode and a second porous electrode comprises depositing a high surface area material on a conductive support. In some embodiments, said step comprises mixing the high surface area carbon material with a binder prior to depositing on the conductive support. The high surface area material can be deposited on the conductive support by any technique known in the art, such as, but not limited to, brushing, spraying, screen printing, and rolling.

Methods of Forming of the Electrochemical Cells Containing Precipitated Salt in the Electrodes

In a further aspect, the present invention provides a method for forming an electrochemical energy storage device comprising at least one electrochemical cell, the method comprising: (a) forming a first porous electrode and a second porous electrode; (b) filling the first porous electrode, the second porous electrode or both electrodes with an aqueous-based or an organic solvent-based solution comprising a dissolved salt comprising a cation selected from the group consisting of Pb²⁺, Sn²⁺, and Sb²⁺; (c) drying the first porous electrode, the second porous electrode or both electrodes; (d) separating the first porous electrode from the second porous electrode by a porous separator; (e) filling the separator with an electrolyte comprising an anion, which forms a precipitated salt with said cation, wherein the electrolyte is in contact with the first porous electrode and with the second porous electrode.

According to some embodiments, said anion is selected from the group consisting of sulfate, carbonate or chloride

According to some embodiments, the method further comprises applying potential to the device to reduce the cation of the precipitated salt to a metallic state on the first porous electrode and to oxidize the cation of the precipitated salt to a metal oxide on the second porous electrode.

According to some embodiments, the electrolyte comprises at least one cation selected from the group consisting of Na⁺, K⁺, Li⁺, Mg²⁺, Ba²⁺, Al³⁺, and Ga³⁺. According to further embodiments, the electrolyte further comprises at least one anion selected from the group consisting of a perchlorate, nitrate, methanesulfonate, trifluoromethanesulfonate, chloride, bromide, hydroxyl, bis(perfluoroethylsulfonyl)imide, carboxylate, acetate and formate.

In some embodiments, the electrolyte is aqueous-based.

In some embodiments, the electrolyte is organic solvent-based. In further embodiments, the organic solvent is selected from the group consisting of ethylene carbonate (EC), propylene carbonate (PC), diethyl carbonate (DEC), dimethyl carbonate (DMC), ethyl formate (EF), methyl formate (MF), 1-ethyl-3-methylimidazolium bis (trifluoromethylsulfonyl)imide, 1-ethyl-3-methylimidazolium trifluoromethanesulfonate, 1-hexyl-3-methylimidazolium hexafluorophosphate, 1-ethyl-3-methylimidazolium dicyanamide, 11-methyl-3-octylimidazolium tetrafluoroborate and combinations thereof.

The step of forming a first porous electrode and a second porous electrode involves the use of a high surface area material, including carbon-based material and transition metal oxides and sulfides. According to some embodiments, the first porous electrode and/or the second porous electrode comprises a high surface area carbon material, selected from the group consisting of carbon, graphite, carbon nanotubes, graphene, and combinations thereof, wherein the high surface area carbon material is configured to incorporate the precipitated salt within the pores thereof. Each possibility represents a separate embodiment of the invention.

According to some embodiments, the first porous electrode and/or the second porous electrode comprises a transition metal oxide or sulfide, selected from the group consisting of MnₙOₓ TiOₓ, NiOₓ CoOₓ, SnOₓ, FeS_{y}, MoS_{y}, NiS_{y}, CoS_{y}, MnS_{y}, TiS_{y}, SnS_{y} and combinations thereof, wherein x ranges from 1.5 to 3, y ranges from 1.8 to 2.2 and n ranges from 1 to 2, wherein the transition metal oxide or sulfide is configured to incorporate the precipitated salt within the pores thereof. In some embodiments, the first porous electrode and/or the second porous electrode comprises a combination of the high surface area carbon and the transition metal oxide or sulfide.

According to some embodiments, the step of forming a first porous electrode and a second porous electrode comprises depositing a high surface area material on a conductive support. In some embodiments, said step comprises mixing the high surface area carbon material with a binder prior to depositing on the conductive support. The high surface area material can be deposited on the conductive support by any technique known in the art, such as, but not limited to, brushing, spraying, screen printing, and rolling.

Methods of Forming of the Electrochemical Cells Containing Pyrite in the Electrodes

In additional aspect, the present invention provides a method for forming an electrochemical energy storage device comprising at least one electrochemical cell, the method comprising: (a) forming a first porous electrode and a second porous electrode, wherein the second porous electrode comprises pyrite (FeS₂) submicron particles; (b) separating the first porous electrode from the second porous electrode by a porous separator; and (c) filling the separator with an aqueous-based or an organic solvent-based electrolyte, wherein the electrolyte in contact with the first porous electrode and with the second porous electrode.

The step of forming a first porous electrode and a second porous electrode involves the use of a high surface area material, including carbon-based material and pyrite. According to some embodiments, the first porous electrode comprises a high surface area carbon material, selected from the group consisting of carbon, graphite, carbon nanotubes, graphene, and combinations thereof. Each possibility represents a separate embodiment of the invention.

According to some embodiments, the second porous electrode comprises a combination of FeS₂ submicron particles and a high surface area carbon material, selected from the group consisting of carbon, graphite, carbon nanotubes, graphene, and combinations thereof. Each possibility represents a separate embodiment of the invention.

According to some embodiments, the step of forming a first porous electrode and a second porous electrode comprises depositing a high surface area material on a conductive support. In some embodiments, said step comprises mixing the high surface area carbon material with a binder prior to depositing on the conductive support. The high surface area material can be deposited on the conductive support by any technique known in the art, such as, but not limited to, brushing, spraying, screen printing, and rolling.

According to some embodiments, the electrolyte comprises at least one cation selected from the group consisting of Na⁺, K⁺, Li⁺, Ca²⁺, Mg²⁺, Ba²⁺, Pb²⁺, Sn²⁺, Sb²⁺, Pb²⁺, Sn²⁺, Sb²⁺, Al³⁺, and Ga³⁺. According to further embodiments, the electrolyte comprises at least one anion selected from the group consisting of a sulfate, perchlorate, nitrate, methanesulfonate, trifluoromethanesulfonate, chloride, bromide, hydroxyl, bis(perfluoroethylsulfonyl)imide, carboxylate, acetate and formate.

In some embodiments, the electrolyte is aqueous-based.

In some embodiments, the electrolyte is organic solvent-based. In further embodiments the organic solvent is selected from the group consisting of ethylene carbonate (EC), propylene carbonate (PC), diethyl carbonate (DEC), dimethyl carbonate (DMC), ethyl formate (EF), methyl formate (MF), 1-ethyl-3-methylimidazolium bis (trifluoromethylsulfonyl)imide, 1-ethyl-3-methylimidazolium trifluoromethanesulfonate, 1-hexyl-3-methylimidazolium hexafluorophosphate, 1-ethyl-3-methylimidazolium dicyanamide, 11-methyl-3-octylimidazolium tetrafluoroborate and combinations thereof.

As used herein and in the appended claims the singular forms “a”, “an,” and “the” include plural references unless the content clearly dictates otherwise. Thus, for example, reference to “a trivalent metal cation” includes a plurality of such trivalent metal cations and equivalents thereof known to those skilled in the art, and so forth. It should be noted that the term “and” or the term “or” is generally employed in its sense including “and/or” unless the content clearly dictates otherwise.

As used herein, the term “about”, when referring to a measurable value such as an amount, a temporal duration, and the like, is meant to encompass variations of +/−20%, more preferably +1-5%, even more preferably +/−1%, and still more preferably +1-0.1% from the specified value, as such variations are appropriate to perform the disclosed methods.

The term “plurality,” as used herein, means two or more.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Example 1—Electrochemical Capacitor Cell Construction and Characterization

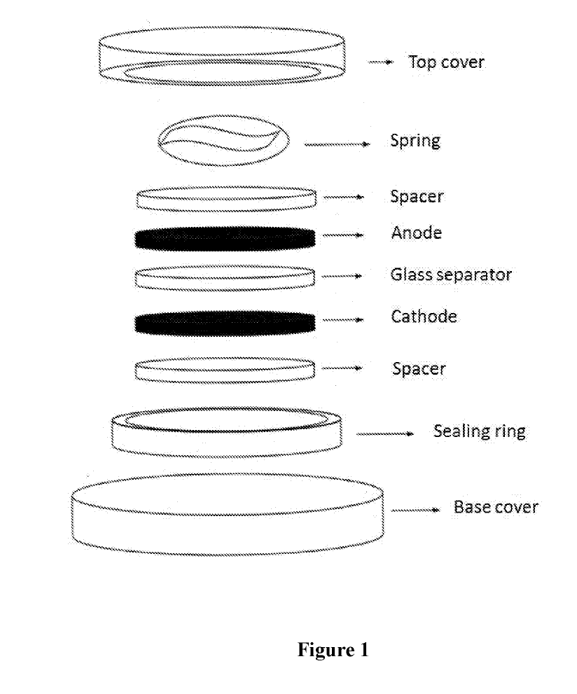

All ECs (also termed herein “cells”) were built according to the scheme, presented in FIG. 1 in a stainless steel coin cell. The cells were constructed and operated at room temperature. In some exemplary embodiments, the electrodes included Norit® carbon (loading 10-20 mg/cm²) on a SGL 25AA carbon paper support and CMC was used as a binder.

The electrodes diameter was 1.2 cm. A 130 μm glass separator was placed between the electrodes. The electrolyte was vacuum filled.

Energy density of the cell was calculated in the [Wh/Kg] units, taking into account the weight of the active material in the first electrode (anode) and in the second electrode (cathode).

Specific capacitance of an electrode in a symmetric cell was calculated in the [F/g] units, taking into account the weight of the active material in said electrode, according to Formula (III):

$${C}_{electrode} [ F \text{/} g ] = \frac{2 \times Qd \times 3.6}{Δ V \times W} \qquad Formula ( III )$$

wherein Qd is the capacity of the cell at discharge, ΔV is the potential window difference, in which the cell was cycled and W the weight of the active mass in the electrode in [gram].

Capacitance of a transition metal electrode (C_{Elec2}) in an asymmetric cell was calculated in the [F] units according to Formula (IV):

$$\frac{1}{{C}_{T}} = \frac{1}{{C}_{Carbon}} + \frac{1}{{C}_{Elec 2}} ; {C}_{Elec 2} = \frac{{C}_{T} * {C}_{Carbon}}{{C}_{Carbon} - {C}_{T}} \qquad Formula ( IV )$$

wherein C_{T} is the capacitance of the asymmetric cell, C_{carbon} is the capacitance of the carbon electrode, wherein C is in the [F] units.

C_{T} was calculated according to Formula (V):

$${C}_{cell} = \frac{Qd \times 3.6}{Δ V} \qquad Formula ( V )$$

C_{carbon} was calculated by using Formula (III) in a cell with symmetric carbon electrodes, similar electrolyte and similar voltage window.

In order to obtain specific capacity, C_{Elec2} was divided by the weight of the active mass in the transition metal electrode in [gram].

The cells were cycled with a Biologic potentiostat.

Symmetric Electrochemical Capacitors

### Example 2—Electrolyte Containing Sodium Ions (Comparative Example)

2 cells (NaTfC1a, NaTfC1b) were built in which the electrolyte was composed of 1.5M sodium triflate (NaSO₃CF₃). The cell performance is shown in table 1. The cell was cycled at a 10 mA constant current in the voltage windows of 0.1V-0.5V, 0.1V-1.6V and 0.1V-1.8V. The capacity and energy density values of these cells can be used as a reference to other symmetric electrochemical capacitors described herein, employing aluminum salts in their electrolytes and/or precipitated lead salts in the electrodes.

Additional cell (NaSu_1c) was built in which the electrolyte was composed of 1M sodium sulfate (Na₂SO₄) and its pH was adjusted to pH=3. The cell performance is shown in table 1. The cell was cycled at a 1 mA constant current in the voltage window of 0.1V-1.8V.

### Example 3—Electrolyte Containing Aluminum Sulfate

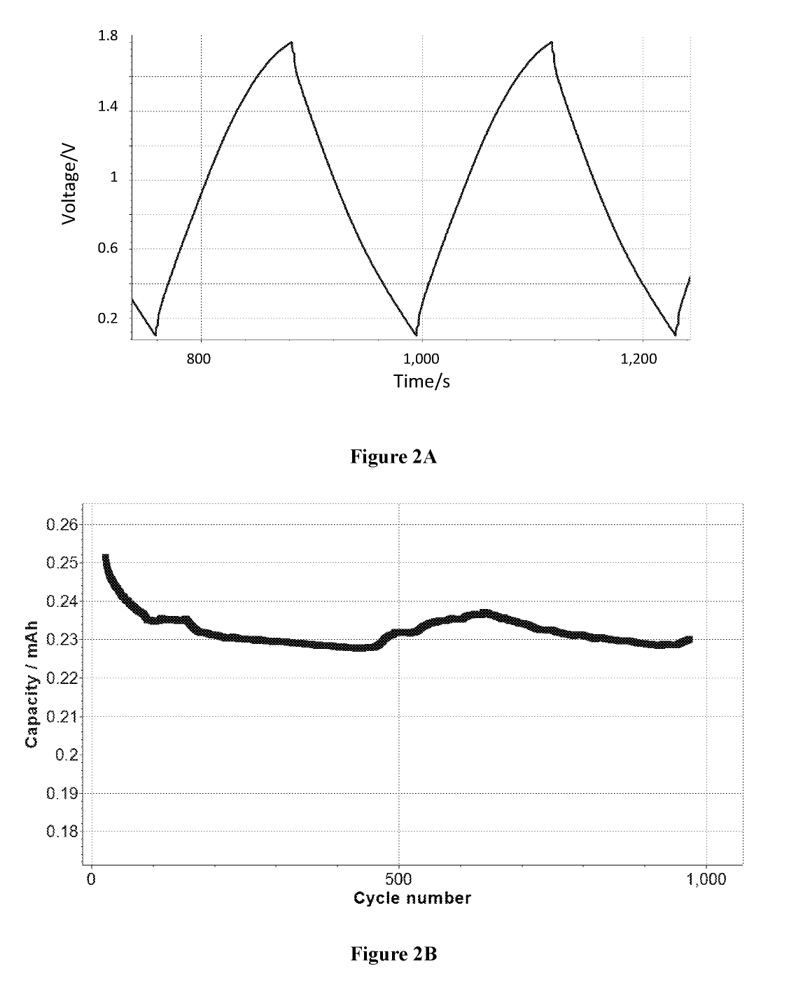

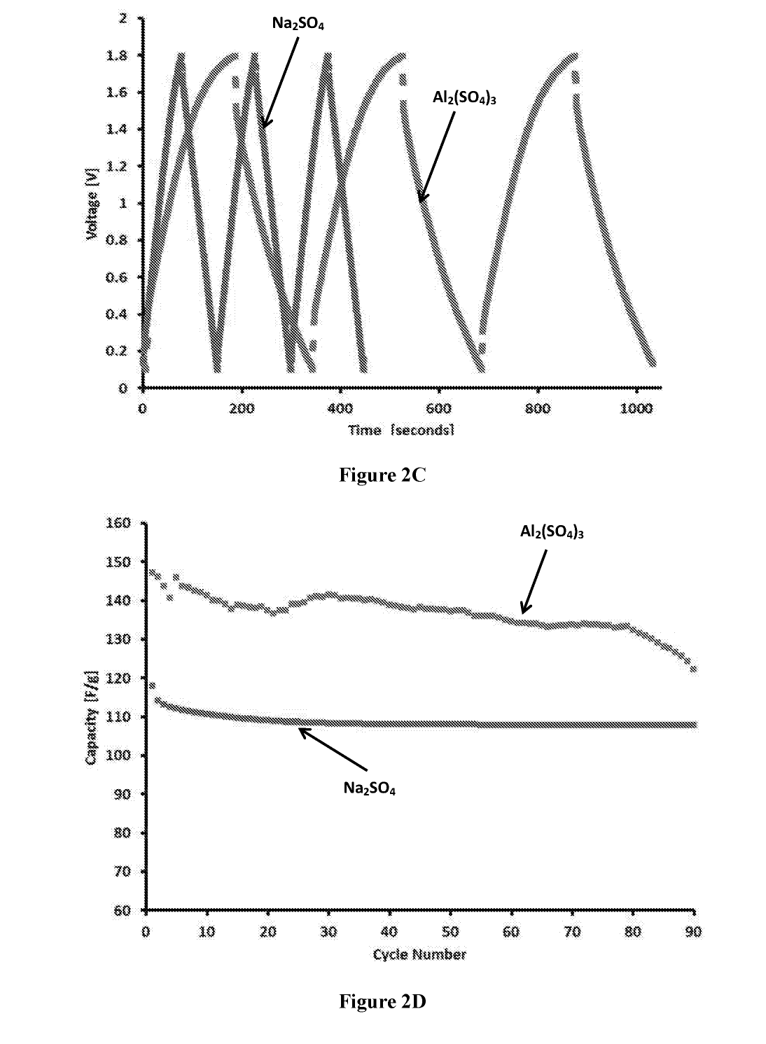

2 cells (AlSulC1a, AlSulC1b) were built in which the electrolyte was composed of 0.8M aluminum sulfate Al₂(SO₄)₃. The cell performance is shown in table 1. The cells were cycled at (i) a 10 mA constant current and (ii) at 2 mA during charge and at 1 mA during discharge in the voltage windows of 0.1V-1.3V and 0.1V-1.8V. The cells exhibited initial discharge capacity of 0.377 mAh (AlSulCla) and 0.312 mAh (AlSulC1b). The energy density was 13.7 Wh/Kg and 14.1 Wh/Kg respectively (calculated based on the total mass of the active materials in both electrodes) and the electrode specific capacitance was 135 F/g(carbon) and 139 F/g(carbon), respectively. AlSul1Cb, which was also cycled at 2 mA at charge and 1 mA at discharge exhibited 23.1 Wh/Kg and 228 F/g. Cell voltage profile is demonstrated in FIG. 2A. Cell cycle life is demonstrated in FIG. 2B.

Compared to reference cells containing sodium triflate, it can be seen that the average (of the two cells) energy density is 11% higher and the average specific capacitance is 10% higher in the aluminum ions-containing cells as compared to the sodium-ions containing cells. Without wishing to being bound by theory or mechanism of action, it can be assumed that the higher specific capacitance and specific energy density values obtained for aluminum sulfate-containing cells is due to the higher positive charge of aluminum ions as compared to sodium ions.

Additional cell (AlSu_5b) was built in which the electrolyte was composed of 0.6M aluminum sulfate Al₂(SO₄)₃ and its pH was adjusted to pH=3. The cell performance is shown in table 1. The cell was cycled at a 1 mA constant current in the voltage window of 0.1V-1.8V. Cell voltage profile as compared to cell NaSu_1c, comprising sodium sulfate electrolyte adjusted to the same pH value is demonstrated in FIG. 2C. Cell cycle life as compared to cell NaSu_1c, is demonstrated in FIG. 2D. It can be seen that the use of aluminum electrolyte enhanced the specific capacity of the symmetric cell by 25% and the energy density by 27%.

### Example 4—Electrolyte Containing Aluminum Nitrate

A cell (AlNO3_1-4) was built using an electrolyte composed of 1.5M (aluminum nitrate) AlNO₃. The cell performance is shown in table 1. The cell was cycled at 10 mA constant current at a voltage window of 0.1V-1.5V. The cell exhibited initial discharge capacity of 0.361 mAh. The energy density was 10.4 Wh/Kg and the electrode specific capacitance was 150 F/g of carbon. In comparison to the sodium electrolyte containing cell, NaTfC1a, operated at the same voltage window, it can be seen that the cell which containing aluminum nitrate in its electrolyte had a 37% larger energy density and 34% higher capacitance.

### Example 5—Electrolyte Containing Lead Ions (Comparative Example)

A cell (NaTfPbC2a) was built using an electrolyte composed of 1.5M Sodium triflate+0.03M lead(II) methanesulfonate (Pb (SO₃CH₃)₂). The cell performance is shown in table 1. The cell was cycled at 10 mA constant current at a voltage window of 0.1V-1.6V. The energy density was 10.2 Wh/Kg and the electrode capacitance was 130 F/g(carbon). Without wishing to being bound by theory or mechanism of action, it can be assumed that the addition of lead ions to the electrolyte expands the operating voltage window. In comparison to the sodium electrolyte containing cell, NaTfC1a, which was operated at the same voltage window, it can be seen that the cell which contains lead ions in its electrolyte has 15% larger energy density and 14% higher capacitance.

### Example 6—Electrolyte Containing Aluminum and Lead Ions

A cell (AlNO3_0.1Pb_1a) was built using an electrolyte composed of 1.5M AlNO₃+0.1M lead(II) methanesulfonate [Pb (SO₃CH₃)₂]. The cell performance is shown in table 1. the cell was cycled at 10 mA constant current at a voltage window of 0.1V-1.35V. The energy density was 6.5 Wh/Kg and the electrode capacitance was 119 F/g(carbon). In comparison to the aluminum sulfate electrolyte containing cell, AlSulC1a, which does not have lead ions in the electrolyte, operated at a voltage window of 0.1V-1.3V, it can be seen that the cell which contains lead ions in its electrolyte has 16% larger energy density and 8% higher specific capacitance. It can be seen that the addition of lead ions to the aluminum ions-contacting electrolyte further increased specific capacity and energy density of the cell.

### Example 7—Electrodes Containing Precipitated Lead Salt

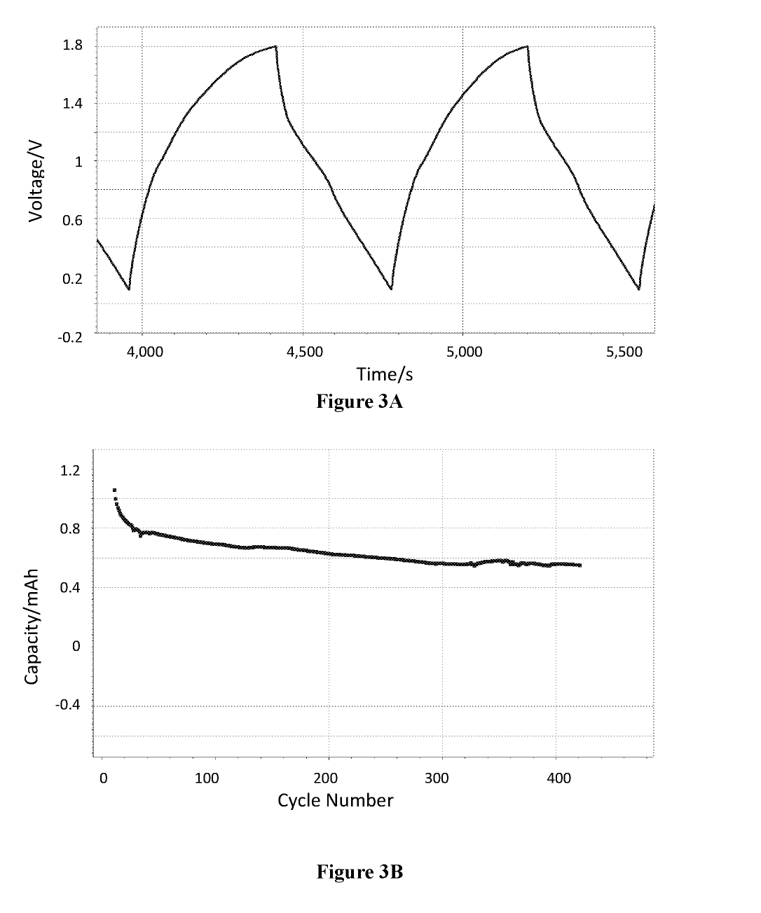

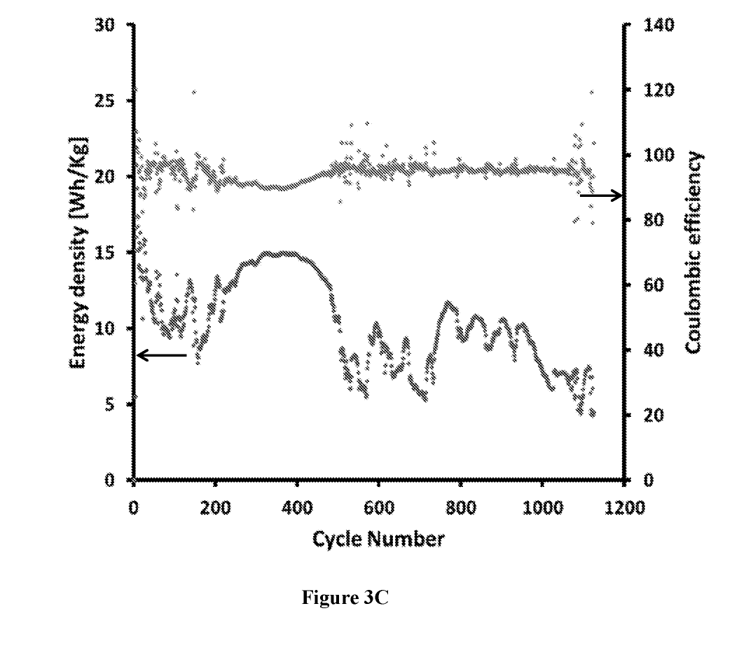

Two cells (Pb7a, Pb7b) were built in which the electrolyte was composed of 0.8M Al₂(SO₄)₃ and PbSO₄ was precipitated on both electrodes of the cell. The electrode contained 13-15.6 mg of Norit® carbon and 3.5-4.7 mg of PbSO₄. The precipitation of PbSO₄ was performed as follows: the carbon electrodes supported on a SGL 25AA carbon paper, wherein carboxymethyl cellulose (CMC) was used as a binder) were vacuumed filled with a solution of 0.5M lead(II) methanesulfonate (Pb (SO₃CH₃)₂) solution. Afterwards, the electrodes were dried at 120° C. for 20 minutes. The electrodes were weighed before and after this procedure in order to determine the weight of the precipitated Pb (SO₃CH₃)₂. Then the electrodes were vacuum filled with a 0.8M Al₂(SO₄)₃ electrolyte. Since lead(II) methanesulfonate is soluble in water, it was dissolved and then lead cations precipitated with sulfate anions as nano particles of PbSO₄, which is not soluble in water. After this step the cell was constructed according to the scheme in FIG. 1 in a stainless steel coin cell. The cells were cycled at a 10 mA constant current in a voltage window of 0.1V-1.8V. As shown in table 1, the cells exhibited initial discharge capacity of 0.842 mAh and 0.963 mAh, energy density was 21 Wh/Kg and 21.1 Wh/Kg and electrode capacitance was 205 F/g and 202 F/g(electrode active material), for Pb7a and Pb7b, respectively. The energy density is increased by 51%, and capacitance is increased by 49%, as compared to the cells containing the same electrolyte but with no precipitated PbSO₄ in the electrodes (AlSulC1a, AlSulC1b. comparison made by the average value of the two cells). It can therefore be concluded that the addition of lead salt to the electrodes as compared to the addition to the electrolyte significantly increases specific capacitance and energy density of the cells. Pb7b cell voltage profile is demonstrated at FIG. 3A. Cell cycle life is demonstrated at FIG. 3B.

Additional symmetric cell (Pb11aT) was built in which the electrolyte was composed of 0.6M Al₂(SO₄)₃ and PbSO₄ was precipitated on both electrodes of the cell. The electrodes included SGL paper coated by activated carbon layer composed of 10 mg/cm2: 82%—Norit Carbon, 10%—CMC binder, 5%—C65 carbon, 3%—High surface area graphite. Precipitation of PbSO₄ was performed as described hereinabove. The weight of the precipitated Pb (SO₃CH3)₂ in the electrode was 50% w/w. Working current was 10 mA/cm² and voltage window was 0.1-2V. The cell performance is shown in table 1. Energy efficiency and coulombic efficiency are shown in FIG. 3C.

Asymmetric Electrochemical Capacitors Based on MnₓOₓ Electrodes

If not specified otherwise, in asymmetric cells carbon-containing electrode (the first electrode) was connected to a negative pole of the potentiostat and was a negative electrode and the transition metal oxide or sulfide electrode (the second electrode) was connected to a positive pole of the potentiostat and was a positive electrode.

### Example 8—Electrolyte Containing Sodium Ions (Comparative Example)

An asymmetric cell (NaSO4_MnO2_1b) was built in which the first electrode was composed of Norit carbon (like in examples 2-7, hereinabove), and the second electrode was composed of micron size MnO₂ powder, Norit® carbon and CMC as a binder. The electrolyte was composed of 2M Na₂SO₄. The cell performance is shown in table 2. The cell was cycled at 1 mA constant current in a voltage window of 0.1V-1.6V. In order to increase energy density and/or capacitance, submicron or even nano-sized MnO₂ powder is used. The capacity and energy density values of this cell can be used as a reference to other asymmetric capacitors containing MnO₂ described herein, employing aluminum salts in their electrolytes.

Additional asymmetric cell (NaSO4_MnO2_2b) was built in which the first electrode was composed of Norit carbon, and the second electrode was composed of micron size MnO₂ powder, Norit® carbon and CMC as a binder. The electrolyte was composed of 1M Na₂SO₄ and its pH was adjusted to pH=3. The cell performance is shown in table 2. The cell was cycled at 1 mA constant current in a voltage window of 0.1V-1.6V.

Another asymmetric cell NaSO4 Mn2O3 9a was built in which the first electrode was composed of Norit carbon and the second electrode was composed of nanosized Mn₂O₃ powder, Norit® carbon and CMC as a binder. The electrolyte was composed of 1M Na₂SO₄ and its pH was adjusted to pH=3. The cell performance is shown in table 2. The cell was cycled at 1 mA constant current in a voltage window of 0.1V-1.6V.

### Example 9—MnO₂-Based Electrode and Electrolyte Containing Aluminum Cations

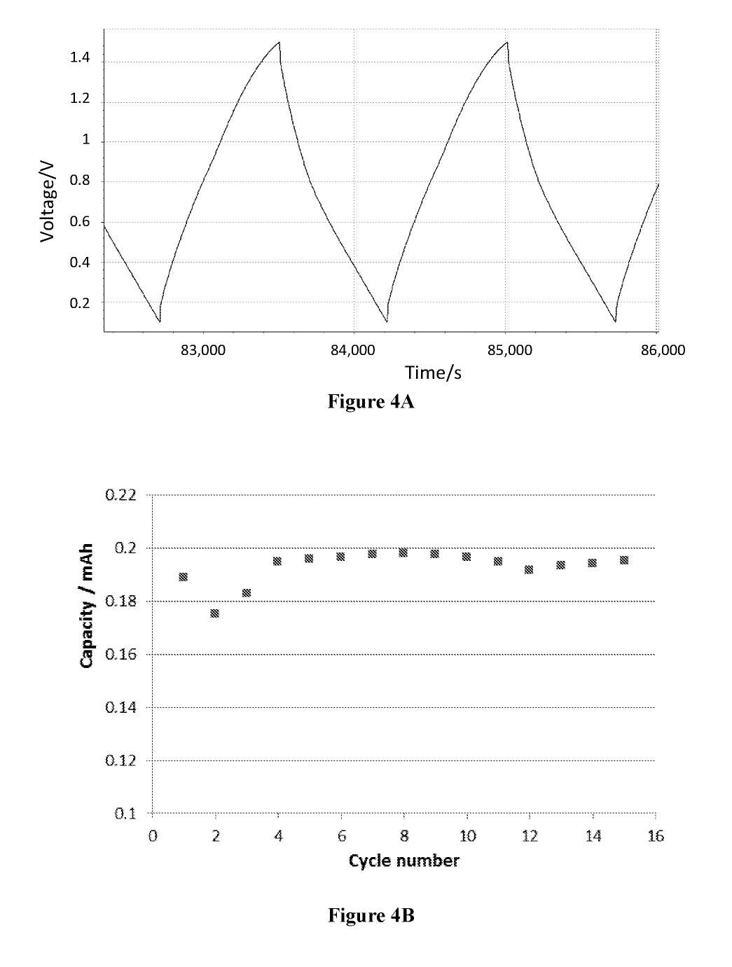

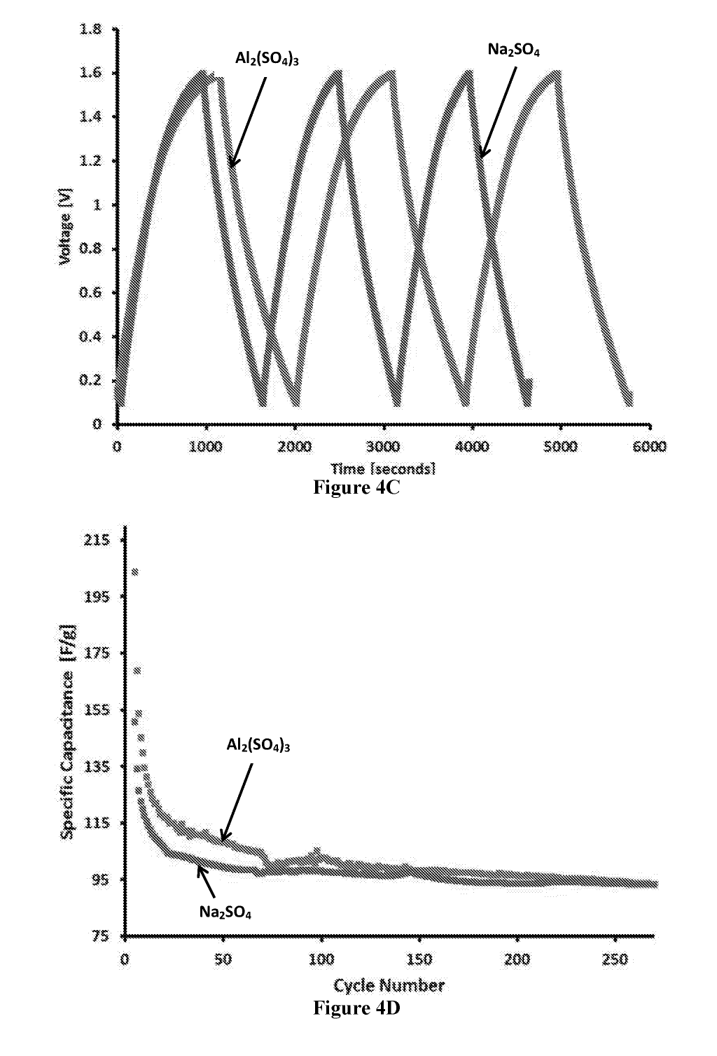

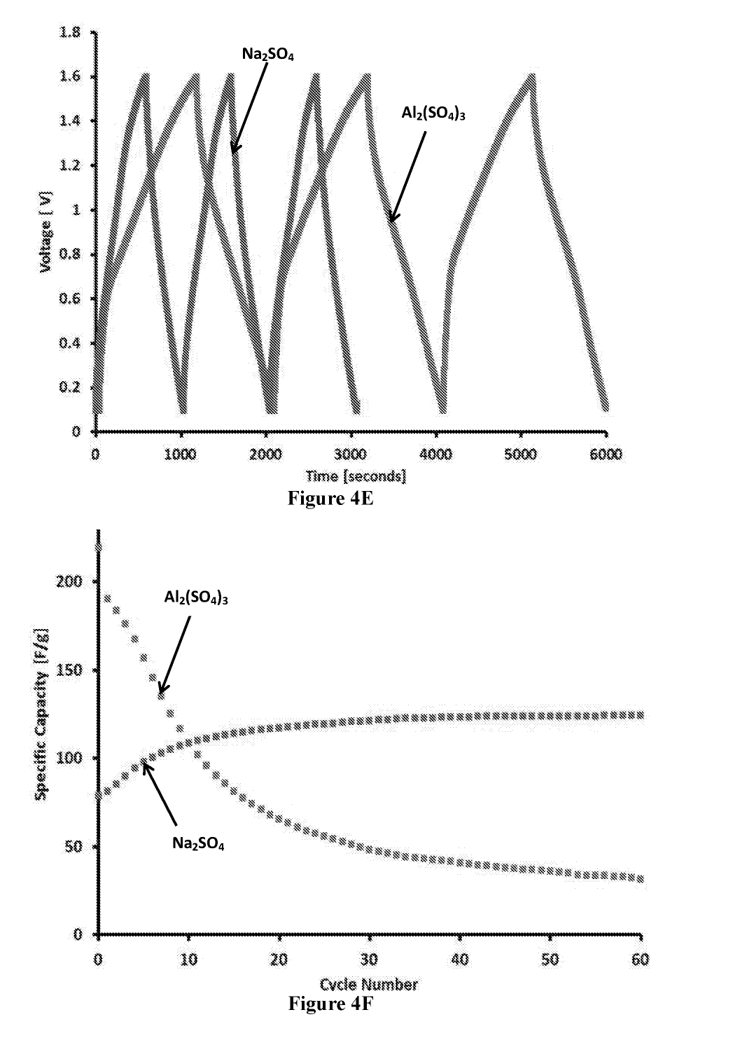

An asymmetric cell (AlSO4_MnO2_1b) was built in which one electrode was composed of Norit® carbon, and the other electrode was composed of MnO₂ and Norit® carbon and CMC as a binder. The electrolyte was composed of 0.8M Al₂(SO₄)₃. The cell performance is shown in table 2. The cell was cycled at a 1 mA constant current in a voltage window of 0.1V-1.6V. The cell exhibited initial discharge capacity of 0.243 mAh. The energy density was 12.4 Wh/Kg and the MnO₂ electrode capacitance was 185 F/g(MnO₂). Compared to the asymmetric cell containing sodium ions in the electrolyte (NaSO4_MnO2_1b), there is an increase of 53% in the specific energy density, and 2.7% increase in specific capacitance. Without wishing to being bound by theory or mechanism of action, it can be contemplated that as in the case of the symmetric electrochemical capacitors, the better performance can be assigned to the higher positive charge of the aluminum ion as opposed to the sodium ion. AlSO4_MnO2_1b cell voltage profile is demonstrated in FIG. 4A. Cell cycle life is demonstrated at FIG. 4B.

Additional asymmetric cell (AlSO4_MnO2_2a) was built in which one electrode was composed of Norit® carbon, and the other electrode was composed of MnO₂ and Norit® carbon and CMC as a binder. The electrolyte was composed of 0.6M Al₂(SO₄)₃ and its pH was adjusted to pH=3. The cell performance is shown in table 2. The cell was cycled at a 1 mA constant current in a voltage window of 0.1V-1.6V. Cell voltage profile as compared to cell NaSO4_MnO2_2b, comprising MnO₂-based electrode and sodium sulfate electrolyte adjusted to the same pH value is demonstrated in FIG. 4C. Cell cycle life as compared to cell NaSO4_MnO2_2b, is demonstrated in FIG. 4D. It can be seen that the use of aluminum electrolyte enhanced the specific capacity and energy density of the asymmetric cell comprising MnO₂, in particular at initial cycles.

Another cell (AlSO4_Mn2O3_7d) was built in which one electrode was composed of Norit® carbon, and the other electrode was composed of nanosized Mn₂O₃ and Norit® carbon and CMC as a binder. The electrolyte was composed of 0.6M Al₂(SO₄)₃ and its pH was adjusted to pH=3. The cell performance is shown in table 2. The cell was cycled at a 1 mA constant current in a voltage window of 0.1V-1.6V. Cell voltage profile as compared to cell NaSO4 Mn2O3 9a, comprising Mn₂O₃-based electrode and sodium sulfate electrolyte adjusted to the same pH value is demonstrated in FIG. 4E. Cell cycle life as compared to cell NaSO4 Mn2O3 9a, is demonstrated in FIG. 4F. It can be seen that the use of aluminum electrolyte enhanced the specific capacity and energy density of the asymmetric cell comprising Mn₂O₃, in particular at initial cycles.

### Example 10—Electrolyte Containing a Combination of Aluminum Cations and Sodium Cations

An asymmetric cell (AlNaSO4_MnO2_1a) was built with electrodes like in example 8-9. The electrolyte was composed of 0.4M Al₂(SO₄)₃+1M Na₂SO₄. The cell performance is shown in table 2. The cell was cycled at 1 mA constant current at a voltage window of 0.1V-1.6V. The cell exhibited initial discharge capacity of 0.202 mAh. The energy density is 10.7 Wh/Kg and the electrode capacitance is 154 F/g of carbon. Compared to the cell containing only sodium cations in its electrolyte, (NaSO4_MnO2_1b) there is an increase of 32% in specific energy density. It can be therefore concluded that even substituting a small portion of the sodium cations with aluminum cations significantly increases specific energy density of the cell.

### Example 11—Electrode Polarity

Mn₂O₃ electrode can be used as a negative or as a positive electrode where the other electrode is a high surface area carbon or another transition metal oxide or sulfide electrode. Two cells were constructed including a high surface area carbon-based electrode and a Mn₂O₃-based electrode. One of the cells contained 0.8M Aluminum sulfate electrolyte (nanoAlMn 3b) and the other contained 1M sodium sulfate (nanoNaMn 3b). The Mn₂O₃-based electrode was connected to the negative pole of the potentiostat (Bio-Logic type).

Negative Electrode—

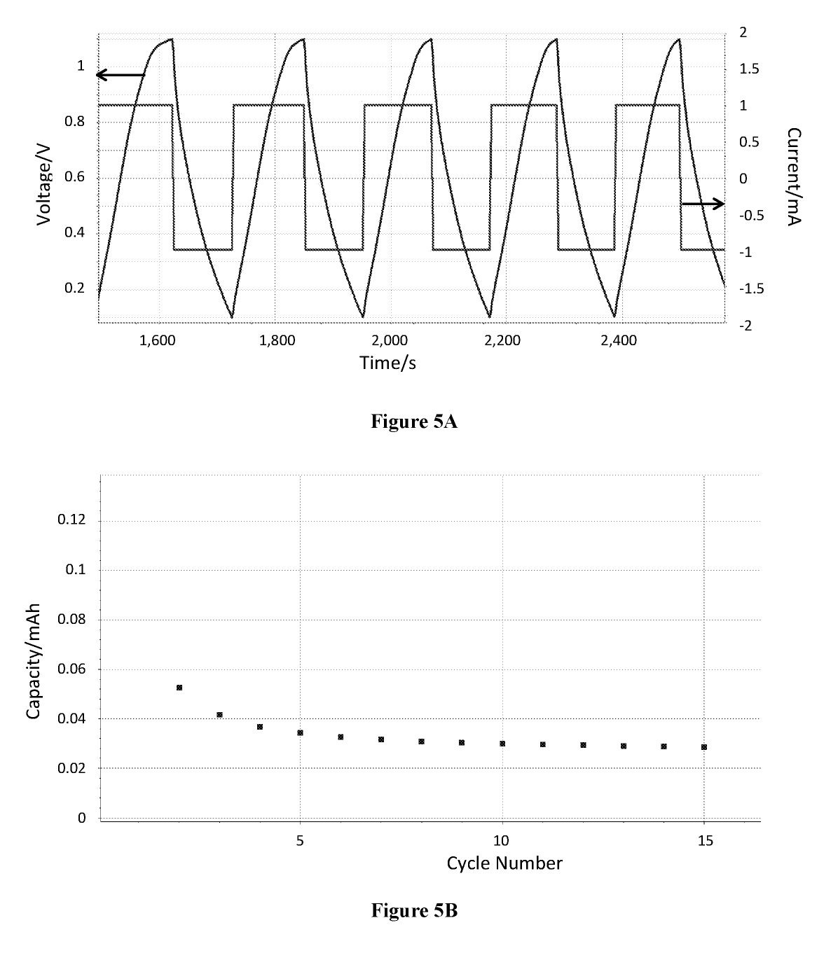

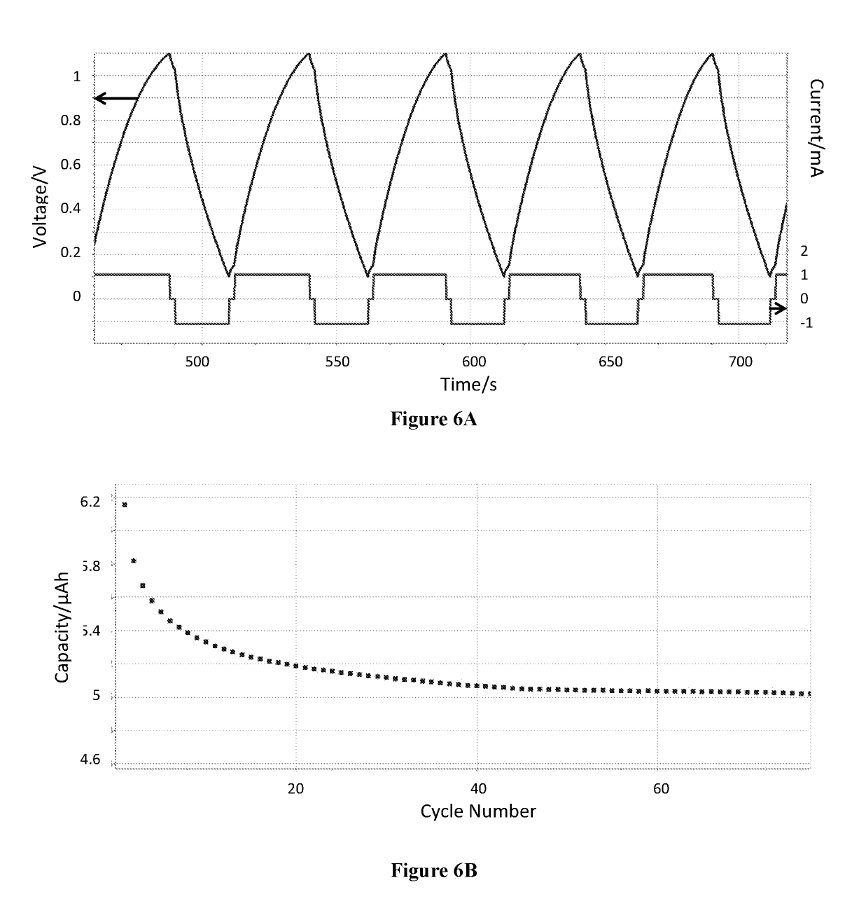

In a charge mode, tested at 0.1V to 1.1V voltage limit, cations are adsorbed on the Mn₂O₃-based electrode (on its surface and possibly under the surface). The capacity of the HDLC with the aluminum-sulfate electrolyte was found to be higher as compared to the Na-based cell (table 2). NanoAlMn_3b cell voltage profile is demonstrated in FIG. 5A and cell cycle life is demonstrated at FIG. 5B. NanoNaMn_3b cell voltage profile is demonstrated in FIG. 6A and cell cycle life is demonstrated at FIG. 6B.

Positive Electrode—

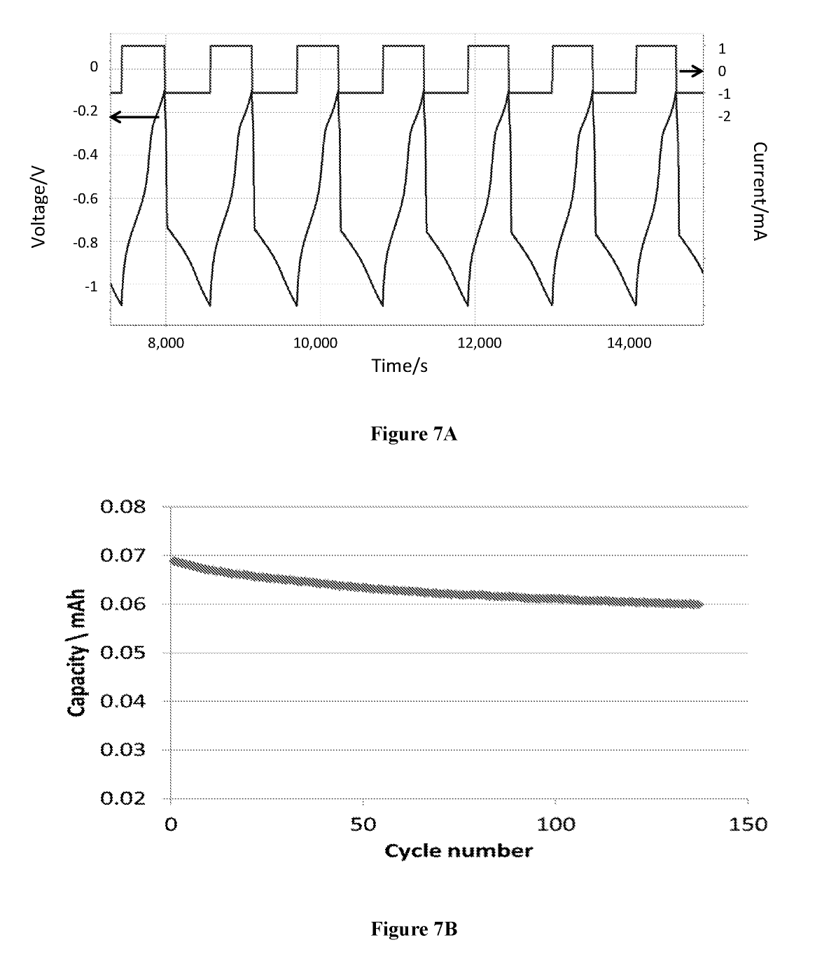

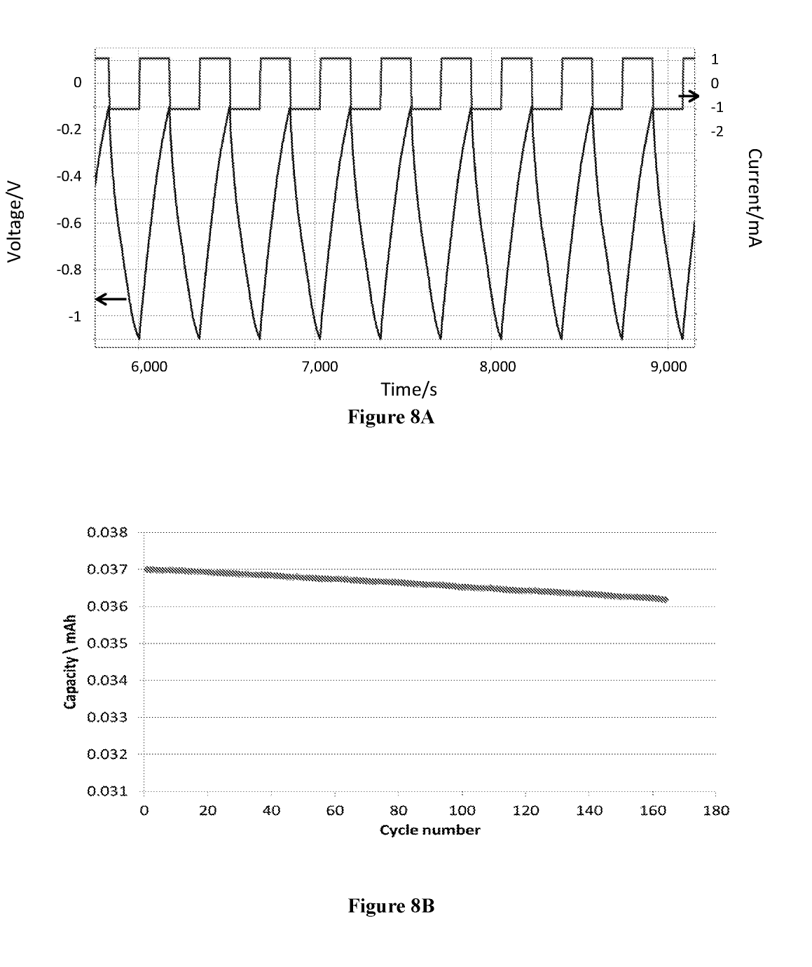

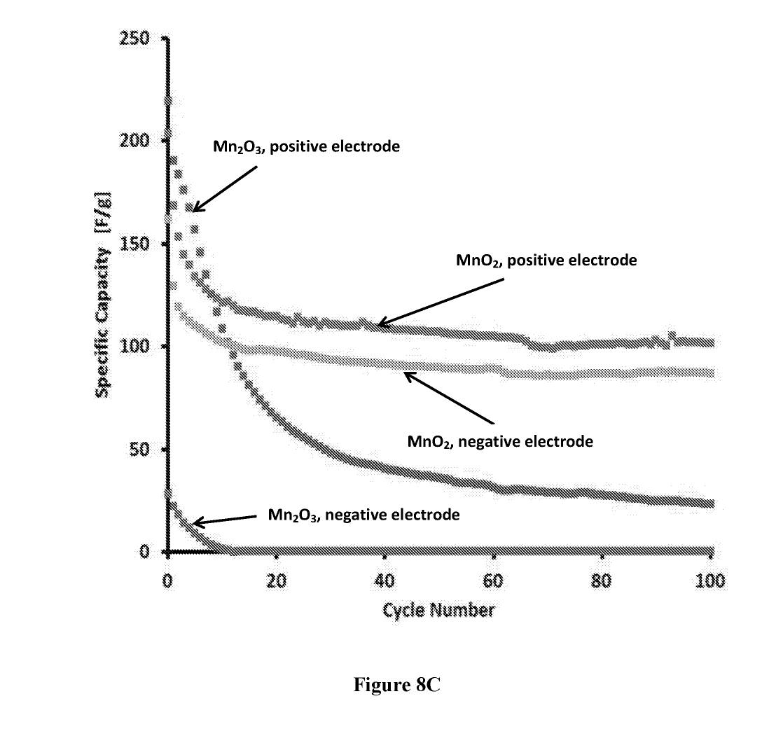

In a charge mode, tested at −0.1V to −1.1V voltage limit (equivalent to connection of the Mn₂O₃-based electrode to the “positive” pole and charging to 1.1V), anions are adsorbed on the Mn₂O₃-based electrode. Anions adsorption resulted in higher capacities (in terms of F per gr of active material of the Mn₂O₃-based electrode) than cations adsorptions, up to 9-fold (table 2). Moreover, the current efficiencies in case of anion adsorption were better and close to 100%. NanoAlMn_3b cell voltage profile is demonstrated in FIG. 7A and cell cycle life is demonstrated at FIG. 7B. NanoNaMn_3b cell voltage profile is demonstrated in FIG. 8A and cell cycle life is demonstrated at FIG. 8B.

AlSO4_MnO2_2a(positive), AlSO4_Mn2O3_7d(positive), AlSO4_MnO2_3a(negative), AlSO4_Mn2O3_8a(negative) cells were also tested with different polarities of the MnO₂ and Mn₂O₃ electrode, wherein the electrolyte contained aluminum sulfate. Cell cycle life of said cells, wherein the transition metal electrodes are connected to positive or negative poles of the potentiostat, is demonstrated in FIG. 8C. It can be seen that both types of the electrodes exhibited higher capacities while working as the positive electrode.

Asymmetric Electrochemical Capacitors Based on MoS₂ Electrodes

### Example 12—Electrolyte Containing Sodium Cations (Comparative Example)

An asymmetric cell (Nasulf_MoS2) was built, which included a first electrode (another) composed of Norit® carbon as specified in examples 2-9, hereinabove and the second electrode containing molybdenum disulfide (having a loading of about 6 mg/cm²). Molybdenum disulfide micron size powder was ball-milled for 1 h prior to the assembly of the electrode. In order to increase energy density and/or capacitance, submicron or even nano-sized MoS₂ powder can be used. The molybdenum disulfide electrode also contained Norit® carbon (14% wt.), graphite (3% wt.) and CMC (8% wt.) as a binder. The paste was rolled on SGL 25AA carbon paper support. This cell contained electrolyte composed of 1M Na₂SO₄. The cell performance is shown in table 2. The capacity and energy density values of this cell can be used as a reference to other asymmetric capacitors containing MoS₂ described herein, employing aluminum salts in their electrolytes.

### Example 13—Electrolyte Containing Aluminum Cations

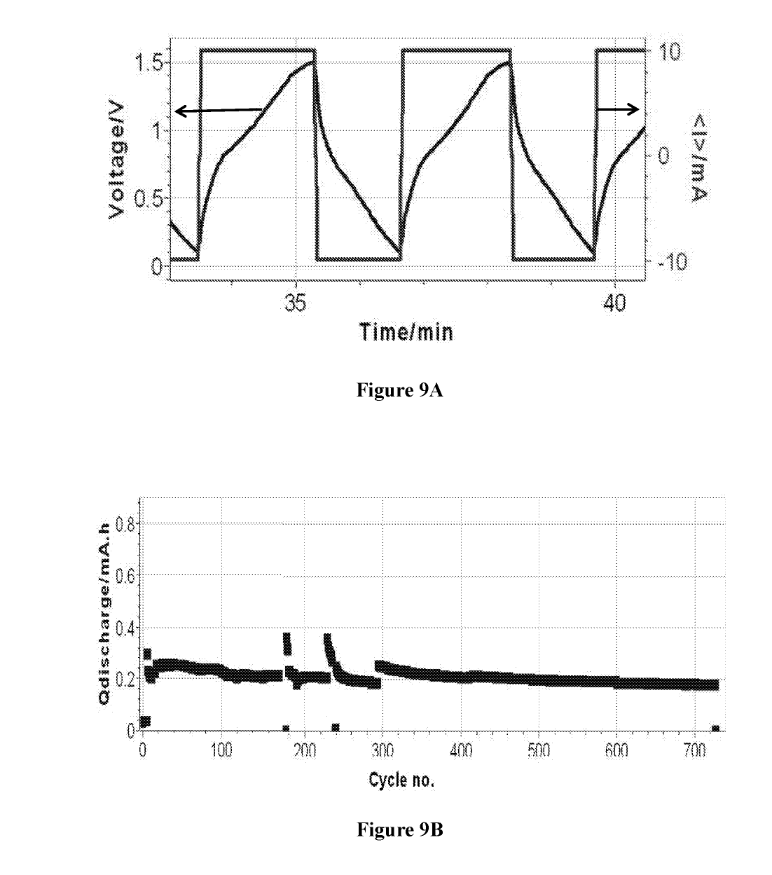

An asymmetric cell (AlSulf MoS2) was built in which the second electrode comprised micron-sized MoS₂ powder as in example 11 hereinabove and the first electrode was composed of Norit® carbon with excessively high loading. This cell contained 0.8M Al₂(SO₄)₃ as an electrolyte. The cell was cycled in a voltage window of 0.1V-1.5V and exhibited discharge capacity of 0.22 mAh at 10 mA current and 0.35 mAh at lower current of 1 mA up to the voltage of 1.35V (as shown in table 2). AlSulf MoS2 cell voltage profile is demonstrated in FIG. 9A. Cell cycle life is demonstrated at FIG. 9B.

### Example 14—Electrode Polarity

MoS₂ electrode can be used as a negative or as a positive electrode where the other electrode is a high surface area carbon or another transition metal oxide or sulfide electrode. Two cells were constructed including a high surface area carbon-based electrode and a MoS₂-based electrode. One of the cells contained 0.8M Aluminum sulfate electrolyte (nanoMo4) and the other contained 1M sodium sulfate (nanoMo5). The MoS₂-based electrode was connected to the negative pole of the potentiostat (Bio-Logic type).

Negative Electrode—

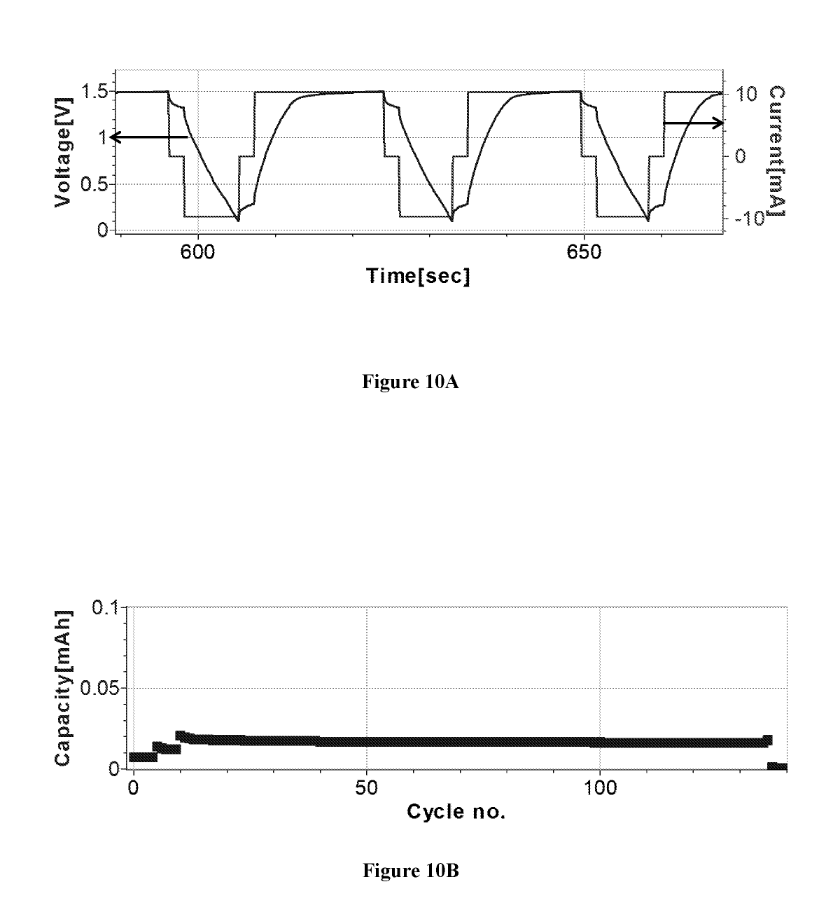

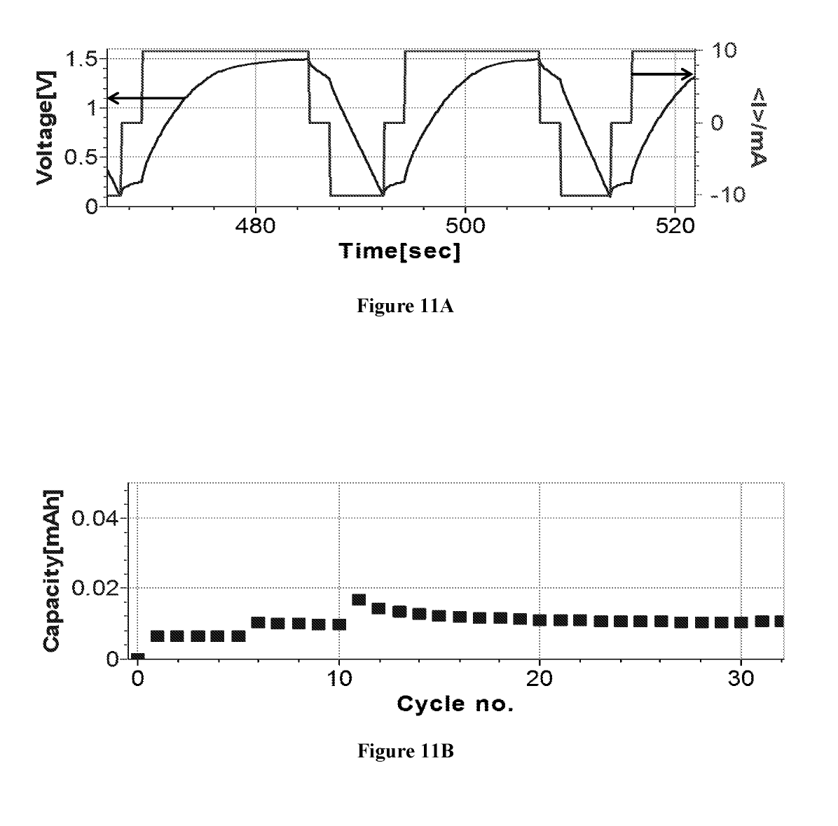

In a charge mode, tested at 0.1V to 1.5V voltage limit, cations are adsorbed on the MoS₂-based electrode (on its surface and possibly under the surface). The capacity of the HDLC with the aluminum-sulfate electrolyte was found to be higher as compared to the Na-based cell (table 2). NanoMo4 cell voltage profile is demonstrated in FIG. 10A and cell cycle life is demonstrated at FIG. 10B. NanoMo5 cell voltage profile is demonstrated in FIG. 11A and cell cycle life is demonstrated at FIG. 11B.

Positive Electrode—

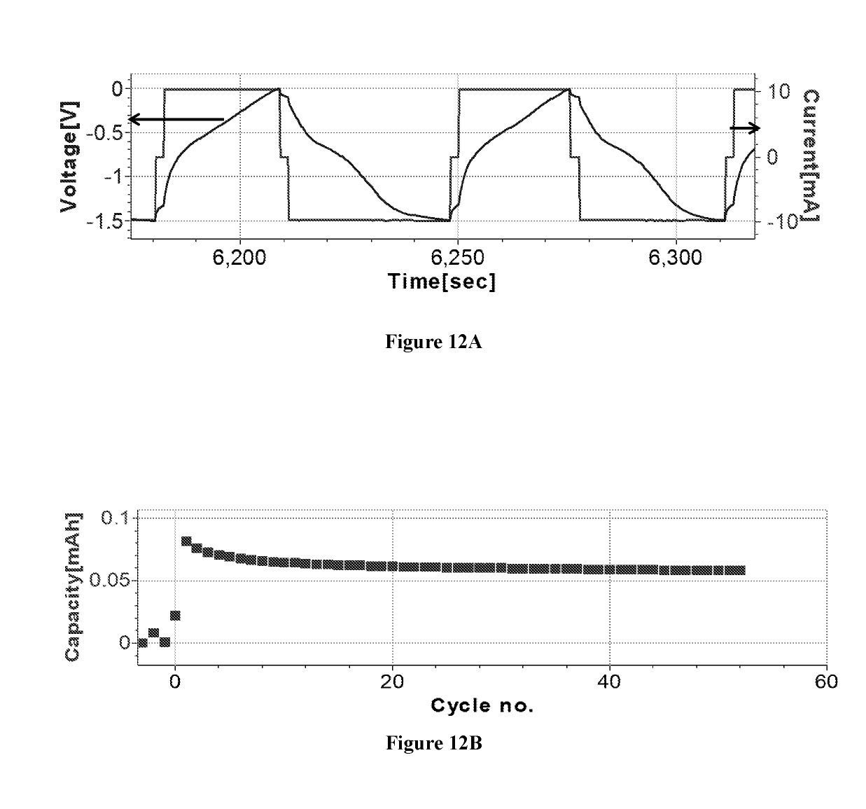

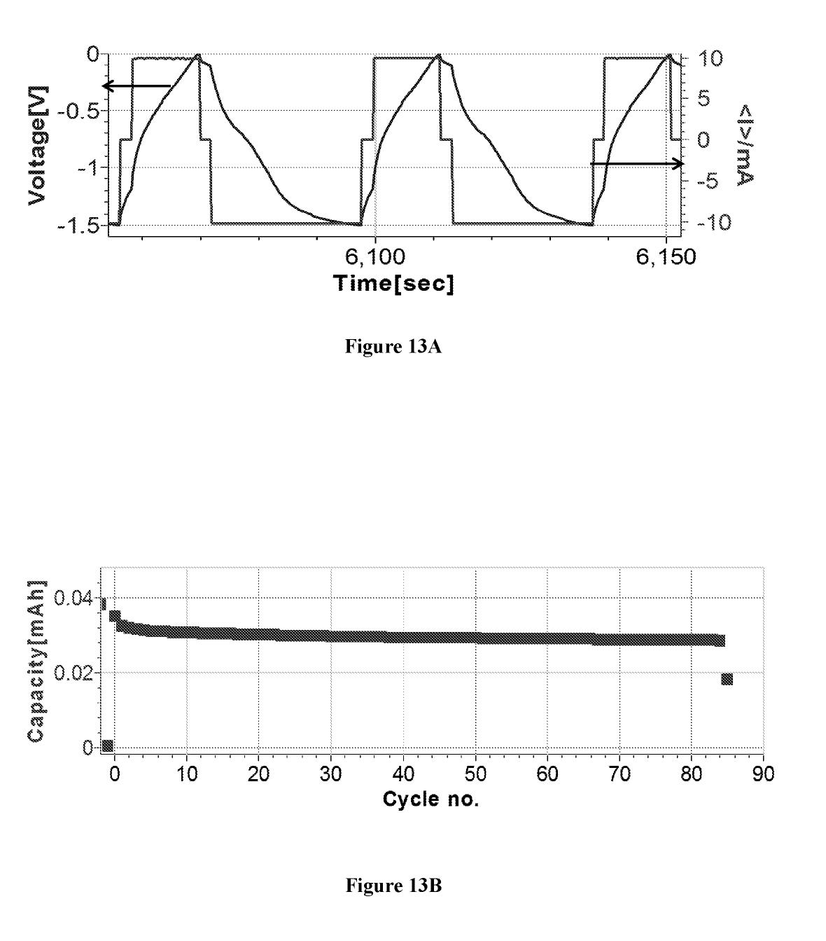

In a charge mode, tested at −0.1V to −1.5V voltage limit (equivalent to connection of the Mn₂O₃-based electrode to the “positive” pole and charging to 1.1V), anions are adsorbed on the Mn₂O₃-based electrode. Anions adsorption resulted in higher capacities (in terms of F per gr of active material of the Mn₂O₃-based electrode) than cations adsorptions, up to 4-fold (table 2). Moreover, the current efficiencies in case of anion adsorption were better and close to 100%. NanoMo4 cell voltage profile is demonstrated in FIG. 12A and cell cycle life is demonstrated at FIG. 12B. NanoMo5 cell voltage profile is demonstrated in FIG. 13A and cell cycle life is demonstrated at FIG. 13B.

Asymmetric Electrochemical Capacitors Based on FeS₂ Electrodes

### Example 15—Symmetric Cell Comprising Two Carbon Electrodes (Comparative Example)

A reference cell was built (LiSulf_Norit) which contained two symmetric electrodes based on Norit® carbon and lithium sulfate as the electrolyte in order to calculate pyrite (FeS₂) electrode capacitance employing the same electrolyte. The cell performance is shown in table 2.

### Example 16—Asymmetric Cells Containing Pyrite Electrodes and Various Electrolytes

Asymmetric cells NaTf_FeS2, NaSulf_FeS2, AlSulf_FeS2 and LiSulf_FeS2 included a second electrode comprising micron-sized pyrite powder which was ball-milled for 4 hours prior to the electrode formation in order to decrease its particle size. The second electrode has a 1.6 mg/cm² loading of pyrite and further contained Norit® carbon (14% wt.), graphite (3% wt.) and CMC (8% wt.) as a binder. The first electrode was based on Norit® carbon as specified in the examples 2-13. Each of the four cells as specified hereinabove was assembled with a different electrolyte, (including 1M NaSO₃CF₃, 1M Na₂SO₄, 0.8M Al₂(SO₄)₃ and 1M Li₂SO₄) and cycled at a 10 mA current density in the 0.1 V-1.4V or 0.1V-1.5V voltage window.

It is appreciated by persons skilled in the art that the present invention is not limited by what has been particularly shown and described hereinabove. Rather the scope of the present invention includes both combinations and sub-combinations of various features described hereinabove as well as variations and modifications. Therefore, the invention is not to be constructed as restricted to the particularly described embodiments, and the scope and concept of the invention will be more readily understood by references to the claims, which follow.

TABLE 1
symmetric cells configuration and performance

| | voltage | | | % | Specific | | | |
|---|---|---|---|---|---|---|---|---|
| | window | Qd | | coulombic | capacitance | Energy density | Current | # of |
| Cell name | [V] | [mAh] | electrolyte | efficiency | [F/g] | Wh/Kg _{(active mass)} | [mA] | cycles |
| NaTfC1a | 0.1-1.8 | 0.285 | 1.5M NaSO₃CF₃ | 93 | 126 | 12.7 | 10 | 1800 |
| NaTfC1a | 0.1-1.5 | 0.208 | 1.5M NaSO₃CF₃ | 99.5 | 112 | 7.6 | 10 | 400 |
| NaTfC1b | 0.1-1.8 | 0.251 | 1.5M NaSO₃CF₃ | 94.8 | 121 | 12.2 | 10 | 10 |
| NaTfC1b | 0.1-1.6 | 0.207 | 1.5M NaSO₃CF₃ | 99.2 | 114 | 8.9 | 10 | 1600 |
| NaSu_1c⁺ | 0.1-1.8 | 0.205 | 1M Na₂SO₄ | 93 | 118 (1-st cycle) | 11 (1-st cycle) | 1 | 600 |
| AlSulC1a | 0.1-1.8 | 0.377 | 0.8M Al₂(SO₄)₃ | 92.3 | 135 | 13.7 | 10 | 2000 |
| AlSulC1a | 0.1-1.3 | 0.218 | 0.8M Al₂(SO₄)₃ | 98.8 | 110 | 5.6 | 10 | 30 |
| AlSulC1b | 0.1-1.8 | 0.312 | 0.8M Al₂(SO₄)₃ | 96.7 | 139 | 14.1 | 10 | 180 |
| AlSulC1b | 0.1-1.8 | 0.511 | 0.8M Al₂(SO₄)₃ | 60.0 | 228 | 23.1 | charge: 2 | 120 |
| | | | | | | | discharge: 1 | |
| AlSu_5b⁺ | 0.1-1.8 | 0.443 | 0.6M Al₂(SO₄)₃ | 89 | 147 (1-st cycle) | 14 (1-st cycle) | 1 | 700 |
| AlNO3_1-4 | 0.1-1.5 | 0.361 | 1.5M AlNO₃ | 86.9 | 150 | 11 | 10 | 400 |
| NaTfPbC2a | 0.1-1.6 | 0.285 | 1.5M NaSO₃CF₃ + | 91.8 | 130 | 10.2 | 10 | 2700 |
| | | | 0.1M Pb (SO₃CH3)₂ | | | | | |
| AlNO3_0.1Pb_1a | 0.1-1.35 | 0.392 | 1.5M AlNO₃ + 0.1M | 90 | 119 | 6.5 | 10 | 600 |
| | | | Pb (SO₃CH3)₂ | | | | | |
| Pb7a | 0.1-1.8 | 0.842 | 0.8M Al₂(SO₄)₃ | 81 | 205 | 21 | 10 | 190 |
| Pb7b | 0.1-1.8 | 0.963 | 0.8M Al₂(SO₄)₃ | 82 | 202 | 21.1 | 10 | 170 |
| Pb11aT | 0.1-2 | 0.503 | 0.6M Al₂(SO₄)₃ | 60 | 207 | 26 (1-st cycle) | 10 | 1100 |

⁺pH of the electrolyte was adjusted to pH = 3.

TABLE 2
asymmetric cells configuration and performance

| | voltage | | | % | Specific | | | |
|---|---|---|---|---|---|---|---|---|
| | window | Qd | | coulombic | capacitance | Energy density | Current | # of |
| Cell name | [V] | [mAh] | electrolyte | efficiency | [F/g] | Wh/Kg _{(active mass)} | [mA] | cycles |
| NaSO4_MnO2_1b | 0.1-1.6 | 0.133 | 2M Na₂SO₄ | 72 | 180 | 8.1 | 1 | 100 |
| NaSO4_MnO2_2b⁺ | 0.1-1.6 | 0.210 | 1M Na₂SO₄ | 71 | 151 (1-st cycle) | 19 (1-st cycle) | 1 | 600 |
| AlSO4_MnO2_1b | 0.1-1.6 | 0.243 | 0.8M Al₂(SO₄)₃ | 73 | 185 | 12.4 | 1 | 50 |
| AlSO4_MnO2_2a⁺ | 0.1-1.6 | 0.272 | 0.6M Al₂(SO₄)₃ | 25 | 204 (1-st cycle) | 23 (1-st cycle) | 1 | 1700 |
| AlSO4_MnO2_3a⁺* | 0.1-1.6 | 0.196 | 0.6M Al₂(SO₄)₃ | 32 | 163 (1-st cycle) | 20 (1-st cycle) | 1 | 400 |
| AlNaSO4_MnO2_1a | 0.1-1.6 | 0.202 | 1M Na₂SO₄ + | 73 | 154 | 10.7 | 1 | 120 |
| | | | 0.4M Al₂(SO₄)₃ | | | | | |
| NaSO4_Mn2O3_9a⁺ | 0.1-1.6 | 0.113 | 1M Na₂SO₄ | 19 | 79 (1-st cycle) | 18 (1-st cycle) | 1 | 70 |
| AlSO4_Mn2O3_7d⁺ | 0.1-1.6 | 0.282 | 0.6M Al₂(SO₄)₃ | 35 | 220 (1-st cycle) | 25 (1-st cycle) | 1 | 200 |
| AlSO4_Mn2O3_8a⁺* | 0.1-1.6 | 0.081 | 0.6M Al₂(SO₄)₃ | 7 | 29 (1-st cycle) | 9 (1-st cycle) | 1 | 180 |
| nanoAlMn_3b* | 0.1-1.1 | | 0.8M Al₂(SO₄)₃ | | 64 | | 1 | |
| nanoAlMn_3b* | −0.1-(−1.1) | | 0.8M Al₂(SO₄)₃ | | 574 | | 1 | |
| nanoNaMn_3b* | 0.1-1.1 | | 1M Na₂SO₄ | | 25 | | 1 | |
| nanoNaMn_3b* | −0.1-(−1.1) | | 1M Na₂SO₄ | | 189 | | 1 | |
| NaSulf_MoS2 | 0.1-2.0 | | 1M Na₂SO₄ | | | | 20 | 50 |
| AlSulf_MoS2 | 0.1-1.5 | | 0.8M Al₂(SO₄)₃ | | 96 | | 10 | 700 |
| nanoMo4* | 0.1-1.5 | | 0.8M Al₂(SO₄)₃ | | 24 | | 10 | |
| nanoMo4* | −0.1-(−1.5) | | 0.8M Al₂(SO₄)₃ | | 100 | | 10 | |
| nanoMo5* | 0.1-1.5 | | 1M Na₂SO₄ | | 19 | | 10 | |
| nanoMo5* | −0.1-(−1.5) | | 1M Na₂SO₄ | | 49 | | 10 | |
| LiSulf_Norit | 0.1-1.8 | | 1M Li₂SO₄ | | | | 10 | 330 |
| NaTf_FeS2 | 0.1-1.4 | | 1M NaSO₃CF₃ | | | | 10 | 2000 |
| NaSulf_FeS2 | 0.1-1.4 | | 1M Na₂SO₄ | | | | 10 | 1900 |
| AlSulf_FeS2 | 0.1-1.4 | | 0.8M Al₂(SO₄)₃ | | | | 10 | 1100 |
| LiSulf_FeS2 | 0.1-1.5 | | 1M Li₂SO₄ | | | | charge: 10 | 800 |
| | | | | | | | discharge: 5 | |

*Transition metal oxide electrode is connected to the negative pole of the potentiostat
⁺pH of the electrolyte was adjusted to pH = 3.

1-41. (canceled)

42. An electrochemical energy storage device, comprising at least one electrochemical capacitor comprising a first porous electrode, a second porous electrode, an electrolyte being in contact with said first porous and second porous electrodes and a porous separator separating the first porous electrode from the second porous electrode, wherein:
a. the electrolyte comprises a first dissolved salt comprising a trivalent post-transition metal cation; and/or
b. wherein the first porous electrode, the second porous electrode or both electrodes comprise submicron particles of a precipitated salt comprising a cation selected from the group consisting of Pb²⁺, Sn²⁺, and Sb²⁺; and/or
c. wherein the second porous electrode comprises submicron particles of pyrite (FeS₂).

43. The device according to claim 42, wherein the trivalent post-transition metal cation is selected from the group consisting of Al³⁺, Ga³⁺, and combinations thereof.

44. The device according to claim 42, wherein the electrolyte comprises a second dissolved salt selected from the group consisting of an alkali metal salt, an alkali earth metal salt and combinations thereof, wherein the alkali metal salt comprises a cation selected from the group consisting of Na⁺, K⁺, and Li⁺; or wherein the alkali earth metal salt comprises a cation selected from the group consisting of Ca²⁺, Mg²⁺, and Ba²⁺.

45. The device according to claim 42, wherein the electrolyte comprises a third dissolved salt comprising a tetravalent post-transition metal salt comprising a cation selected from Pb²⁺ or Sn²⁺.

46. The device according to claim 45, wherein the first salt, the second salt, and/or the third salt comprises at least one anion selected from the group consisting of a sulfate, perchlorate, nitrate, methanesulfonate, trifluoromethanesulfonate, chloride, bromide, hydroxyl, bis(perfluoroethylsulfonyl)imide, carboxylate, acetate and formate.

47. The device according to claim 44, wherein the concentration of the first dissolved salt and/or of the second dissolved salt is in the range of from about 0.1M to about 10M.

48. The device according to claim 42, wherein the electrolyte is an aqueous-based electrolyte.

49. The device according to claim 42, wherein the electrolyte is an organic solvent-based electrolyte, wherein the organic solvent is selected from the group consisting of ethylene carbonate (EC), propylene carbonate (PC), diethyl carbonate (DEC), dimethyl carbonate (DMC), ethyl formate (EF), methyl formate (MF), 1-ethyl-3-methylimidazolium bis (trifluoromethylsulfonyl)imide, 1-ethyl-3-methylimidazolium trifluoromethanesulfonate, 1-hexyl-3-methylimidazolium hexafluorophosphate, 1-ethyl-3-methylimidazolium dicyanamide, 11-methyl-3-octylimidazolium tetrafluoroborate and combinations thereof.

50. The device according to claim 42, wherein the first porous electrode, the second porous electrode or both electrodes comprise a high surface area carbon material.

51. The device according to claim 50, wherein the high surface area carbon material is selected from the group consisting of carbon, graphite, carbon nanotubes, graphene, and combinations thereof.

52. The device according to claim 42, wherein the first porous electrode, the second porous electrode or both electrodes comprise a transition metal oxide or sulfide.

53. The device according to claim 52, wherein the transition metal oxide or sulfide is selected from the group consisting of MnₙOₓ, TiOₓ, NiOₓ, CoOₓ, SnOₓ, FeS_{y}, MoS_{y}, NiS_{y}, CoS_{y}, MnS_{y}, TiS_{y}, SnS_{y} and combinations thereof, wherein x ranges from 1.5 to 3, y ranges from 1.8 to 2.2 and n ranges from 1 to 2.

54. The device according to claim 53, wherein the second electrode comprises FeS₂.

55. The device according to claim 42, wherein the submicron particles of the precipitated salt are deposited in the pores of the first porous electrode and/or of the second porous electrode.

56. The device according to claim 42, wherein the precipitated salt comprises an anion selected from the group consisting of sulfate, carbonate and chloride.

57. The device according to claim 42, wherein the cation of the precipitated salt is reduced to metallic state on the first porous electrode and/or is oxidized to a metal oxide on the second porous electrode during potential cycling of the device.

58. The device according to claim 57, wherein the first electrode comprises submicron particles of a metal selected from the group consisting of Pb, Sn, and Sb and/or wherein the second electrode comprises submicron particles of a metal oxide selected from the group consisting of PbO₂, SnO₂, and SbO₂.

59. The device according to claim 42, wherein the first porous electrode comprises high surface area carbon material, the second porous electrode comprises high surface area carbon material and the electrolyte is an aqueous-based electrolyte consisting essentially of dissolved Al³⁺ salt.

60. The device according to claim 42, wherein the first porous electrode comprises high surface area carbon material; the second porous electrode comprises transition metal oxide or sulfide selected from the group consisting of MnOₓ, MoS_{y} and FeS₂, wherein x ranges from 1.5 to 3 and y ranges from 1.8 to 2.2; and the electrolyte is an aqueous-based electrolyte consisting essentially of dissolved Al³⁺ salt.

61. The device according to claim 42, wherein the first porous electrode and the second porous electrode comprise high surface area carbon material and the submicron particles of the precipitated salt comprising a cation selected from the group consisting of Pb²⁺, Sn²⁺, and Sb²⁺, wherein the submicron particles are deposited in the pores of said electrodes.

62. The device according to claim 61, wherein the precipitated salt comprises a PbSO₄ salt.

63. The device according to claim 61, wherein the electrolyte is an aqueous-based electrolyte comprising a trivalent post-transition metal cation.

64. The device according to claim 42, wherein the first porous electrode comprises high surface area carbon material, the second porous electrode comprises transition metal oxide or sulfide and wherein the first electrode and the second electrode further comprise the submicron particles of the precipitated salt comprising a cation selected from the group consisting of Pb²⁺, Sn²⁺, and Sb²⁺, wherein the submicron particles are deposited in the pores of said electrodes.

65. The device according to claim 64, wherein the precipitated salt comprises a PbSO₄ salt.

66. The device according to claim 64, wherein the electrolyte is an aqueous-based electrolyte comprising a trivalent post-transition metal cation.

67. The device according to claim 42, wherein the first porous electrode comprises high surface area carbon material and the second porous electrode comprises FeS₂ submicron particles.

68. A method for forming an electrochemical energy storage device comprising at least one electrochemical capacitor, the method comprising:
a. forming a first porous electrode and a second porous electrode;
b. filling the first porous electrode, the second porous electrode or both electrodes with an aqueous-based or an organic solvent-based solution comprising a dissolved salt comprising a cation selected from the group consisting of Pb²⁺, Sn²⁺, and Sb²⁺;
c. drying the first porous electrode, the second porous electrode or both electrodes;
d. separating the first porous electrode from the second porous electrode by a porous separator;
e. filling the separator with an electrolyte comprising an anion, which forms a precipitated salt with said cation, wherein the electrolyte is in contact with the first porous electrode and with the second porous electrode.

69. The method according to claim 68, wherein said anion is selected from the group consisting of sulfate, carbonate and chloride.

70. The method according to claim 68, further comprising applying potential to the device to reduce the cation of the precipitated salt to a metallic state on the first porous electrode and to oxidize the cation of the precipitated salt to a metal oxide on the second porous electrode.

71. The method according to claim 68, wherein the electrolyte comprises at least one cation selected from the group consisting of Na⁺, K⁺, Li⁺, Ca²⁺, Mg²⁺, Ba^{2+,} Al³⁺, and Ga³⁺.
